(19) United States
(12) Patent Application Publication
(10) Pub. No.: US 2024/0070428 A1
(43) Pub. Date: Feb. 29, 2024

(54) TRACKING TAGS

(71) Applicant: X Development LLC, Mountain View, CA (US)

(72) Inventors: Ricky Yik Hei Ngan, Mountain View, CA (US); Phillip Yee, San Francisco, CA (US); Connor Burgess, San Francisco, CA (US); Dean Kawaguchi, San Jose, CA (US); Kin Seto, San Carlos, CA (US); Russell Shikami, Cupertino, CA (US)

(21) Appl. No.: 18/228,951

(22) Filed: Aug. 1, 2023

Related U.S. Application Data
(60) Provisional application No. 63/446,375, filed on Feb. 17, 2023.
(60) Provisional application No. 63/400,891, filed on Aug. 25, 2022.

(51) Int. Cl. G06K 19/077; G06K 19/07

(52) U.S. Cl. CPC G06K 19/07722; G06K 19/0702

(57) ABSTRACT

Aspects of the disclosure provide tracking tags. As an example, a tracking tag may include beacon transmission circuitry including one or more batteries, a frame configured to hold the one or more batteries in place, an adhesive arranged to secure the tracking tag to an object, and an activation mechanism configured to activate the tracking tag and cause the beacon transmission circuitry to transmit beacon signals in order to enable tracking of the object.

### CROSS REFERENCE TO RELATED APPLICATIONS

The present application claims the benefit of the filing date of U.S. Provisional Application No. 63/446,375, filed Feb. 17, 2023 and U.S. Provisional Application No. 63/400,891, filed Aug. 25, 2022, the entire disclosures of which are incorporated by reference herein.

### BACKGROUND

The Internet of Things (IoT) is the inter-networking of physical objects, such as products, packages, vehicles, buildings, etc., that are embedded with electronic components for network connectivity. The embedded components enable objects to detect others, be detected by others, collect data and/or transmit data. In some examples, the embedded components may include tags or labels attached to the physical objects. These tags or labels may be passive or active. The inter-networking capabilities may be leveraged for tracking locations of physical objects. In many situations, objects may be moved at different points in time, such as a package or equipment moved from a truck to a loading dock to a warehouse, or medical equipment that is moved between different rooms (or floors) in a hospital. These types of situations can be very challenging to determine the location of the object with suitable accuracy, including updating of the location as it changes. In addition, systems that use GPS or WiFi may suffer from signal dropout or transmitters going offline, which can reduce the ability to properly identify an object's location.

### BRIEF SUMMARY

Aspects of the disclosure provide for tracking tags. As an example, a tracking tag includes beacon transmission circuitry including one or more batteries; a frame configured to hold the one or more batteries in place; an adhesive arranged to secure the tracking tag to an object; and an activation mechanism configured to activate the tracking tag and cause the beacon transmission circuitry to transmit beacon signals in order to enable tracking of the object.

In one example, the tracking tag also includes an adhesive label. In this example, the adhesive label is a sheet of polyester or paper with an adhesive backing. In addition, the adhesive backing is a double-sided tape. In another example, the frame comprises a polycarbonate. In another example, the frame is a flexible frame which enables the tracking tag to be attached to objects having curved surfaces. In another example, the beacon transmission circuitry further includes a printed circuit board. In another example, the beacon transmission circuitry is arranged on a backing sheet. In this example, the backing sheet is a polycarbonate sheet. Alternatively, the backing sheet is an RFID inlay. In another example, the one or more batteries includes a coin cell, prismatic, pouch, thin-film or screen-printed battery. In another example, the frame includes a plurality of subframes which enable the tracking tag to be flexed between ones of the plurality of subframes. In this example, a first subframe of the plurality of subframes is configured to support a first one of the one or more batteries, and a second subframe of the plurality of subframes is configured to support a second one of the one or more batteries. In addition, a third subframe of the plurality of subframes is configured to support a printed circuit board of the beacon transmission circuitry. In another example, the tracking tag also includes a top cover and a bottom cover to provide impact protection. In this example, the top cover and the bottom cover comprise polycarbonate. In another example, the tracking tag has a thickness of less than 2.3 mm. In another example, the adhesive is a double-sided tape. In another example, the tracking tag also includes a removable sheet arranged on the adhesive in order to protect the adhesive prior to application of the tracking tag to an object. In another example, the activation mechanism includes a switch tab. In another example, the activation mechanism includes a liner sheet which includes a portion that wraps around and partially through the tracking tag in order to prevent a connection between the one or more batteries and another component of the beacon transmission circuitry and the liner sheet is configured to be removed from the tracking tag in order to activate the tracking tag. In another example, the activation mechanism further includes a conductive adhesive to form a bond between the one or more batteries and a copper tape once the tracking tag has been activated. In another example, the activation mechanism includes a pull tab. In another example, the activation mechanism includes a button configured to be pressed in order to activate the tracking tag. In another example, the activation mechanism includes an initially open circuit. In another example, the activation mechanism includes an initially closed circuit. In another example, the tracking tag also includes a Silicon Controlled Rectifier (SCR) circuit configured to maintain a connection in the beacon transmission circuitry once the tracking tag is activated. In another example, the activation mechanism includes a thermal switch. In another example, the activation mechanism includes a magnetic switch. In another example, the activation mechanism includes a removable bridge. In another example, the tracking tag also includes a light configured to flash when the tracking tag is activated. In another example, the frame is comprised of foam and functions as a gasket. In another example, the beacon transmission circuitry further includes an antenna, an integrated chip, and a capacitor. In another example, the tracking tag is arranged on a roll with a plurality of tracking tags.

### BRIEF DESCRIPTION OF THE DRAWINGS

FIG. 1A illustrates various examples for localization of objects in accordance with aspects of the technology.

FIG. 1B is a functional diagram of an example tracking system in accordance with aspects of the disclosure.

FIG. 2 is a pictorial diagram of an example network in accordance with aspects of the disclosure.

FIG. 3 is a functional diagram of the example network in FIG. 2 in accordance with aspects of the disclosure.

FIGS. 4A-B illustrate example scenarios in accordance with aspects of the disclosure.

FIG. 5 is an example cross-sectional view of an example configuration of a tracking tag in accordance with aspects of the disclosure.

FIGS. 6A and 6B are example representations of bending a tracking tag in accordance with aspects of the disclosure.

FIG. 7 is an example side-perspective view of a tracking tag in accordance with aspects of the disclosure.

FIGS. 8A, 8B and 8C represent example configurations of a tracking tag in accordance with aspects of the disclosure.

FIG. 9 is a detail side cross-sectional view of a tracking tag in accordance with aspects of the disclosure.

FIGS. 10A, 10B, 10C provide an example assembly process for a tracking tag in accordance with aspects of the disclosure.

FIG. 11 provides an example exploded view of a subassembly of a tracking tag in accordance with aspects of the disclosure.

FIGS. 12A and 12B provide perspective views of subassemblies of tracking tags 1100 in accordance with aspects of the disclosure.

FIG. 13 is an example partial cross-sectional view of a tracking tag in accordance with aspects of the disclosure.

FIGS. 14A and 14B provide example perspective views of a subassembly of a tracking tag in accordance with aspects of the disclosure.

FIGS. 15A, 15B, 15C, 15D, 15E and 15F provide cross-sectional views of a tracking tag, an activation mechanism, and a process for activating the tracking tag in accordance with aspects of the disclosure.

FIGS. 16A, 16B, 16C provide cross-sectional views of a tracking tag, an activation mechanism, and a process for activating the tracking tag in accordance with aspects of the disclosure.

FIGS. 17A and 17B provide a simplified representation of a reed switch of a circuit that includes a PCB and one or more batteries in accordance with aspects of the disclosure.

FIG. 18 provides an example representation of a bridge arranged on a tracking tag in accordance with aspects of the disclosure.

FIGS. 19A and 19B provide a simplified example representation of a pull tab in a circuit in accordance with aspects of the disclosure.

FIG. 20 is a functional diagram for an example manual provisioning process in accordance with aspects of the disclosure.

FIG. 21A is a functional diagram for an example partially automated provisioning process in accordance with aspects of the disclosure.

FIG. 21B is an example perspective view of a tracking tag in accordance with aspects of the disclosure.

FIG. 22 is a functional diagram for an example partially or fully automated provisioning process in accordance with aspects of the disclosure.

FIG. 23 is a functional diagram for an example partially or fully automated provisioning process in accordance with aspects of the disclosure.

FIGS. 24A and 24B are example perspective views of tracking tag rolls in accordance with aspects of the disclosure.

FIG. 25 is an example of an exploded view of a tracking tag in accordance with aspects of the disclosure.

### DETAILED DESCRIPTION

### Overview

Accurate localization and tracking of objects can be important for a number of reasons, including knowing where supplies or equipment are stored and whether additional materials need to be ordered. In a warehouse setting, once arriving at the warehouse pallets of goods may be moved to different locations depending on storage limitations, when the goods need to be shipped out, and where the goods are going. In a commercial or hospital setting, equipment may be stored in one location (e.g., a storeroom), placed in different rooms for use, and then moved when the need arises, such as moving a hospital bed from one room to another.

In order to track such objects, tracking tags may be used, and in order to enable the use of the aforementioned tracking tags on as many different types of objects and locations as possible, the tracking tags may be designed to be both thin and flexible. In addition, each tracking tag may be passive, such as a tracking tag configured to activate or be powered by environmental energy, or active, configured to include a battery or be coupled to another power source. In the case of a battery, delaying activation of the battery until the end user is ready to use the tracking tag is critical to extending the useful life of the tracking tag.

Tracking tags may include various components such as a top adhesive label, a frame, beacon transmission circuitry, an adhesive (for attaching the tracking tag to objects), and top and bottom covers. The adhesive label may be printed on during manufacturing and/or by the end user before application of the tracking tag on an object. The beacon transmission circuitry may include a printed circuit board (PCB) and one or more batteries. The PCB may include various features such as an identifier chip and/or a transmission device for the purposes of enabling the aforementioned beacon signals. The one or more batteries may include a coin cell, prismatic, pouch, thin-film, or screen-printed battery. The top and bottom covers may provide impact protection, prevent the ingress of liquids and other contaminants, as well as provide a smooth surface for applying labels or on which to print information (whether or not an adhesive label is not used). In addition, a liner sheet may be used to protect the adhesive before the tracking tag is attached to an object.

The frame may be formed from various materials and may be die-cut, molded or manufactured using other processes. The materials of the frame may be selected in order to enable the frame to be strong and puncture resistant while also flexible. In some instances, the frame may be comprised of a plurality of sub-frames each configured to support a component such as one of the one or more batteries, a PCB, etc.

The tracking tags may also include an activation mechanism configured to activate the tracking tag and initiate transmission of beacon signals by the beacon transmission circuitry. Example activation mechanisms may include a switch tab, a liner sheet which includes a portion that wraps around and partially through the tracking tag in order to prevent a connection between the one or more batteries and another component of the beacon transmission circuitry and the liner sheet is configured to be removed from the tracking tag in order to activate the tracking tag, a pull tab, a button configured to be pressed in order to activate the tracking tag, an initially open circuit, an initially closed circuit, a thermal switch, a magnetic switch, and a removable bridge.

These various different activation mechanisms may be combined with different engagement mechanisms. For instance, while an activation mechanism may be used to activate a tracking tag, an engagement mechanism for a circuit (e.g., beacon transmission circuitry) may be used in order to maintain the connections in the circuit once the tracking tag is activated. Engagement mechanisms may include a mechanical latching mechanism or a physically latching switch, an electrically latching mechanism, a normally closed circuit, and so on.

Different approaches for printing top adhesive labels, applying top adhesive labels, registering the tracking tags, activating the tracking tags, and attaching the tracking tags to an object or “provisioning processes” may be used. During the registration part of this provisioning process, information such as tracking tag identifiers, tracking numbers, as well as information about the objects themselves, such manufacturing data (e.g., manufacturing date, serial number, etc.) may need to be registered with one or more server computing devices in order to enable information about the object to be tracked in the storage system. The provisioning process may be a completely manually, partly automated or completely automated process. In addition, different manufacturing processes may be used to produce the tracking tags described herein on rolls.

The features described herein may provide for tracking tags with various benefits. Such tracking tags may have a thin profile while still being flexible, thus enabling the use of such tracking tags on any number of different types of objects. In other words, the same tracking tags may be suitable for attachment to objects with various form factors without the need to modify the shape and configuration of the tracking tags thereby simplifying the tracking of objects. In addition, the tracking tags described herein may be printed on and/or labels attached with information which may include identifying numbers, tracking numbers, etc. which can be converted to digital representations.

### Example Systems

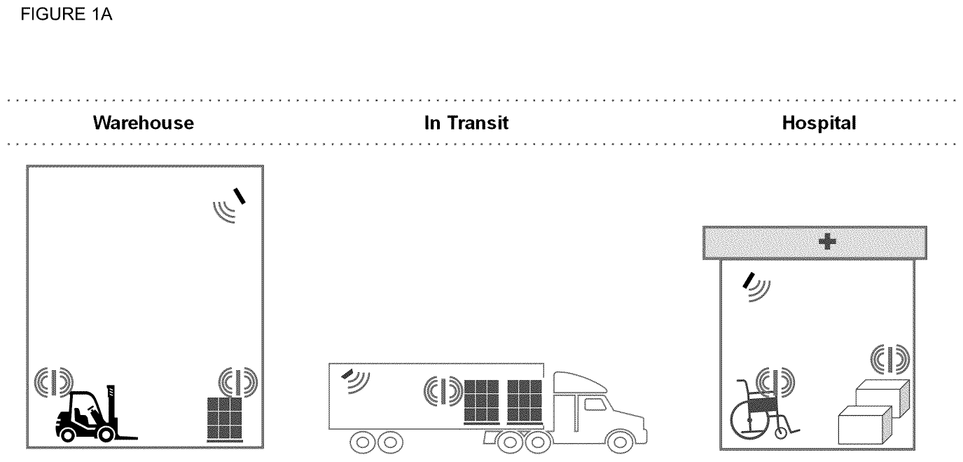

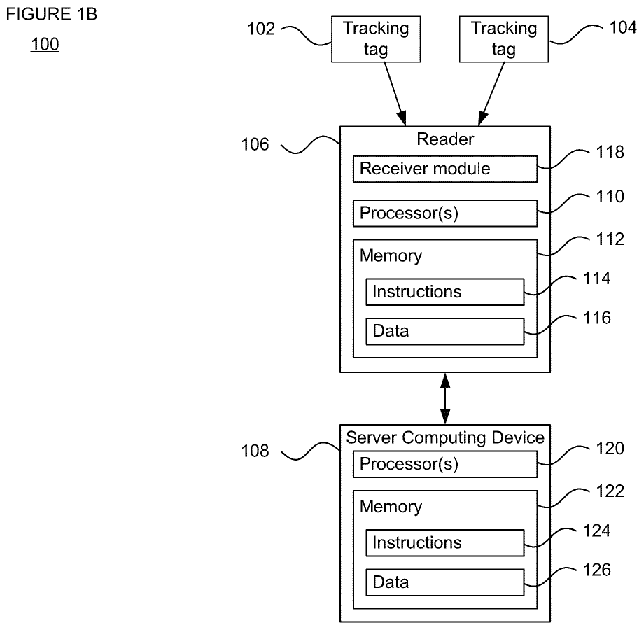

FIG. 1A illustrates examples of different objects in various environments. As shown on the left side image of the figure, there may be packages or equipment on a pallet in a warehouse. The pallet may have come off of a cargo truck as shown by the “In Transit” image in the middle of the figure. The pallet may be moved to one or more different locations within a warehouse, such as by the forklift shown in the left side image. The right-side image in the figure illustrates a situation where medical equipment (e.g., a wheelchair) and supplies in boxes may be stored in a supply room in a hospital.

In all of these situations—in the warehouse, on the cargo truck, or at the hospital, the objects of interest may move around. That may be to a different aisle or room in the warehouse, a different room (or even a different floor) of the hospital, or different part of the cargo container of the truck. In the latter case, the cargo may have shifted during transit or may have been repositioned as different packages were delivered to different locations. Knowing where the objects of interest are currently located, as opposed to where they are presumed to be based on an initial placement, is a valuable piece of information for an office manager, warehouse manager, nurse or orderly to have. Ideally, such people should be able to get the current location of a given object on their client computing device such as a laptop, mobile phone or smartwatch.

FIG. 1B is a functional diagram of a tracking system 100. The tracking system 100 may include a plurality of tracking devices, such as tracking tags 102 and 104, and a reader 106. As discussed further below, one or more server computing devices 108 may also be part of the tracking system 100. A given tracking tag may be placed on or otherwise attached to or inserted into an object to be tracked, such as a package, a piece of equipment, a vehicle, a warehouse section, a room, etc. While tracking tags 102 may be associated with objects such as packages, equipment or vehicles (e.g., a forklift or an autonomous fulfillment robot that can retrieve packages from different locations in a warehouse), tracking tags 104 may be fixed to an aisle in a warehouse or from a specific room in a hospital. Thus, different tracking tags may be used depending upon customer needs. As an example, different customers may have varying accuracy and “liveliness” needs. For instance, one customer may only want to know aisle-level accuracy every day (e.g., before a warehouse closes for the evening), while another customer such as a hospital nurse may need to know which room a piece of equipment is in every hour so that it can be accessed should a patient need such equipment. Each tracking tag 102 or 104 may emit an informational signal, for example a beacon signal, via an antenna, such as using the transmitting device, to communicate data. In this regard, each tracking tag may include an identifier chip (such as for radiofrequency (RF) identification) and/or a transmitting device (such as an RF module configured to transmit beacon signals using a selected frequency band and transmission protocol). In this regard, the beacon signals may simply transmit identifying information in order to enable tracking of objects in the case of tracking tags discussed further below. To facilitate this, each tracking tag may be embedded with a unique identifier, such as a unique MAC address or BLUETOOTH identifier, which may function as a tracking tag identifier. This tracking tag identifier may be assigned to the tracking tag during the manufacturing or provisioning processes (described further below).

The transmitting device may send such information via radio frequency transmission in a selected frequency band, using a standard or proprietary protocol. By way of example, the transmitting device may employ a BLUETOOTH (e.g., a BLUETOOTH Low Energy (BLE)) or 802.11 protocol in the 2.4 GHz and/or 5 GHz frequency bands. In some examples, each beacon tracking tag and each tracking tag uses the BLUETOOTH or BLE protocol.

In some instances, the tracking tags may include one or more sensors. In such instances, the aforementioned communicated data may be formatted according to the selected protocol and include one or more sensed characteristics of the given tracking tag or its environment. For example, the sensed characteristic may be a temperature, a location, motion, battery conditions, trip conditions, and/or other detectable characteristics of the tracking devices or its environment.

The reader 106 may be a computing device configured to detect the beacon signals emitted by the plurality of tracking tags 102 and 104, then store and/or transmit data related to the tracking tags. While only one reader is shown in FIG. 1B, the system may employ multiple readers. The reader 106 may include one or more processors 110, memory 112 and other components typically present in general purpose computing devices. The reader 106 includes a receive module 118 having an antenna and a processing section (not shown), which may include a bandpass filter for the frequency band of interest, an analog to digital (A/D) converter, and a signal processing module to evaluate information in received beacon signals. The processing section may also convert the received beacon signal to a baseband signal, before or after A/D conversion.

The one or more processors 110 may be any conventional processors, such as commercially available CPUs or microcontrollers. Alternatively, the one or more processors may be a dedicated device such as an ASIC or other hardware-based processor, such as a field programmable gate array (FPGA). Although FIG. 1B functionally illustrates the processor(s), memory, and other elements of the reader 106 as being within the same block, the processor, computing device, or memory may actually include multiple processors, computing devices, or memories that may or may not be stored within the same physical housing. For example, memory may be a hard drive, a removable USB drive or other storage media located in a housing different from that of the reader 106. Accordingly, references to a processor or computing device will be understood to include references to a collection of processors or computing devices or memories that may or may not operate in parallel.

The memory 112 stores information accessible by the one or more processors 110, including instructions 114 and data 116 that may be executed or otherwise used by the processor(s) 110. The data may include sensed characteristics from any of the tracking tags 102 and/or 104 received by the reader 106. The memory 112 may be of any type capable of storing information accessible by the processor(s), including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The data 116 may be retrieved, stored or modified by processor(s) 110 in accordance with the instructions 114. For instance, although the claimed subject matter is not limited by any particular data structure, the data may be stored in computing device registers, in a relational database as a table having a plurality of different fields and records, XML documents or flat files. The data may also be formatted in any computing device-readable format.

The instructions 114 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

In some implementations, the tracking system 100 may further include a central server, such as one or more server computing devices 108 accessible by the one or more processors 110 of the reader 106. In some implementations, one or more tracking devices in the tracking system 100, such as a tracking tag 104, may be configured to obtain and communicate data directly to the one or more server computing devices 108. The one or more server computing devices 108 may include one or more processors 120, memory 122 and other components typically present in general purpose computing devices. The one or more processors 120 may be the same or similar type as the one or more processors 110, and the memory 122 may be the same or similar type as the memory 112. The memory 122 stores information accessible by the one or more processors 120, including instructions 124 and data 126 that may be executed or otherwise used by the processor(s) 120. Data 126 and instructions 124 may be the same or similar type as the data 116 and instructions 114, respectively.

After detecting the beacon signals of one or more tracking tags 102 or 104, the reader 106 may transmit the data from the tracking tags to the one or more server computing devices 108 through an existing connection or through a network. Thus, in this case the reader 106 may include a transmitter module (not shown) that is configured for wired or wireless transmission to the server computing device. The data may be received in a series of payloads (e.g., data packets) either continually, at one or more set intervals, or ad hoc whenever the tracking tags transmit. Thus, when there are multiple tracking tags, the data is effectively received as a plurality of separate data streams. A given payload (which may comprise one or more data packets) may include measurements taken at one or more time intervals, each of which may have a corresponding timestamp. In one scenario, the reader 106 may include a transceiver including both a receiver and a transmitter, which is configured to receive beacon signals from the tracking tags 102 and 104 and also to send and receive information with the server computing device 108.

The one or more server computing devices 108 may be configured to track characteristics of the tracking devices for one or more alerts based on a plurality of conditions. The plurality of conditions may include at least one condition for each characteristic, such as a minimum, a maximum, a threshold, a duration, or a geofence. The conditions may be predetermined or set based on user input. For example, a first alert may be set for when (1) a temperature is greater than, e.g., 0° C. to 10° C. for 30 minutes and (2) the tracking device is on a trip, which may indicate overheating of a cooled package or storage compartment. A second alert may be set for when (1) no motion is detected for 10 minutes, (2) 2 of 3 locations are in a geofence, and (3) the tracking device is on a trip, which may indicate that a package is out for delivery. A third alert may be set for when (1) a threshold amount of light is detected from inside a package and (2) the tracking device is on a trip, which may indicate unexpected opening of the package or tampering. A fourth alert may be set for when (1) a threshold amount of light is detected from inside a package and (2) 2 of 3 locations are in a destination geofence, which may indicate opening of the package after delivery or receipt. Many other alert conditions and tracking scenarios are possible, and the above examples are not intended to be limiting.

The tracking system 100 may optionally include an application that may be installed on one or more client computing devices. Using the application, the client computing devices may access the data from the reader 106 and/or the server computing device 108 through a network.

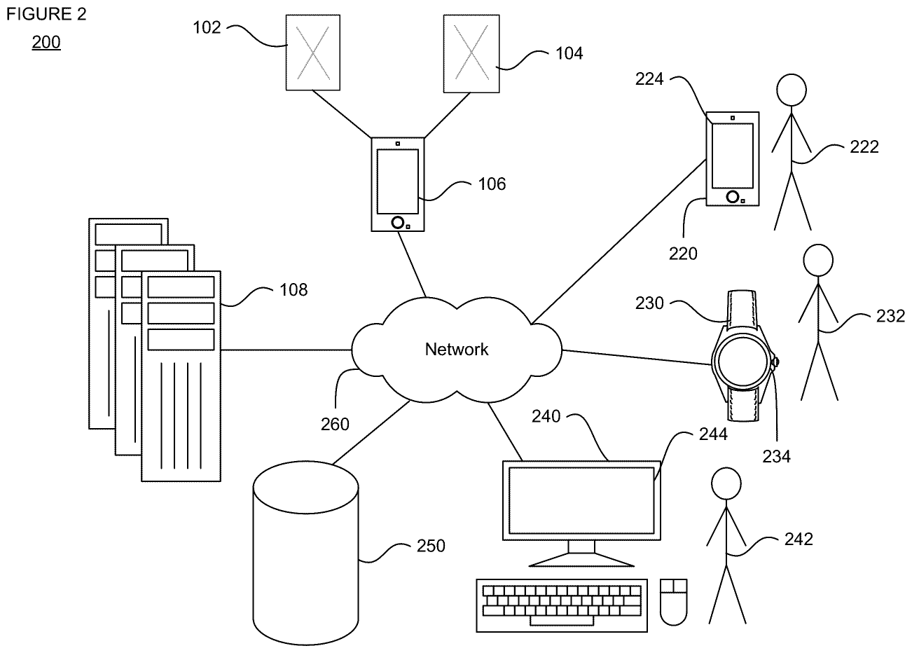

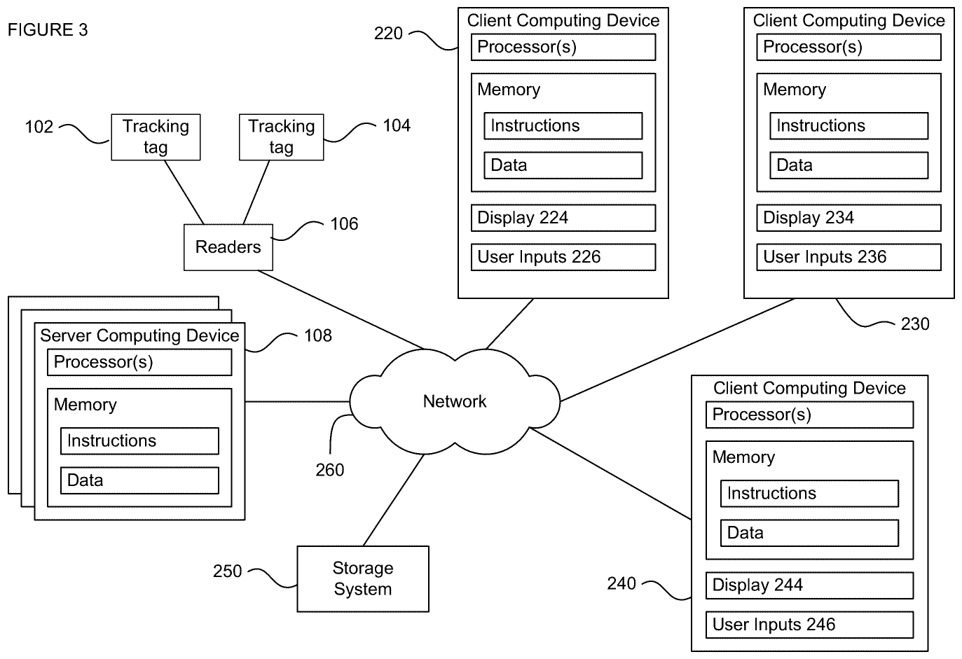

FIGS. 2 and 3 are pictorial and functional diagrams, respectively, of an example system 200 that includes a plurality of client computing devices 220, 230, 240 and a storage system 250 connected via a network 260. System 200 also includes tracking system 100, including tracking tags 102, 104, reader 106, and server computing device 108. Although only a few tags and computing devices are depicted for simplicity, a typical system may include significantly more.

Using the client computing devices, users, such as user 222, 232, 242, may view the location data on a display, such as displays 224, 234, 244 of respective client computing devices 220, 230, 240. As shown in FIG. 3, each client computing device 220, 230, 240 may be a personal computing device intended for use by a respective user and have all of the components normally used in connection with a personal computing device including a one or more processors (e.g., a central processing unit (CPU)), memory (e.g., RAM and internal hard drives) storing data and instructions, a display such as displays 224, 234, 244 (e.g., a monitor having a screen, a touch-screen, a head-mounted display, a smartwatch display, a projector, a television, or other device that is operable to display information), and user input devices 226, 236, 246 (e.g., one or more of a mouse, keyboard, touch screen and/or a microphone). The client computing devices may also include speakers, a network interface device, and all of the components used for connecting these elements to one another.

Although the client computing devices 220, 230, and 240 may each comprise a full-sized personal computing device, they may alternatively comprise mobile computing devices capable of wirelessly exchanging data with a server over a network such as the Internet. By way of example only, client computing device 220 may be a mobile phone or a device such as a wireless-enabled PDA, a tablet PC, a wearable computing device or system (e.g., a smartwatch or head-mounted display, or a netbook that is capable of obtaining information via the Internet or other networks. As an example, the user may input information using a small keyboard, a keypad, microphone, using visual signals (gestures) with a camera or other sensor, or a touch screen.

As with memory 112, storage system 250 can be of any type of computerized storage capable of storing information accessible by the one or more server computing devices 108, such as a hard-drive, memory card, ROM, RAM, DVD, CD-ROM, write-capable, and read-only memories. In addition, storage system 250 may include a distributed storage system where data is stored on a plurality of different storage devices which may be physically located at the same or different geographic locations. Storage system 250 may be connected to the computing devices via the network 260 as shown in FIG. 2, and/or may be directly connected to or incorporated into any of the client computing devices 220, 230, 240. The storage system 250 may store information about the tracking tags including, for example, location, status (e.g., activated and when), identifiers, last update, sensor data (e.g., temperature measurements), information about the object to which the tracking tag is attached (e.g., manufacturing data), and so on. In this regard, the information may be determined from received beacon signals provided to and updated at the storage system 250 by any of the one or more server computing devices 108 and/or client computing devices 220, 230, 240.

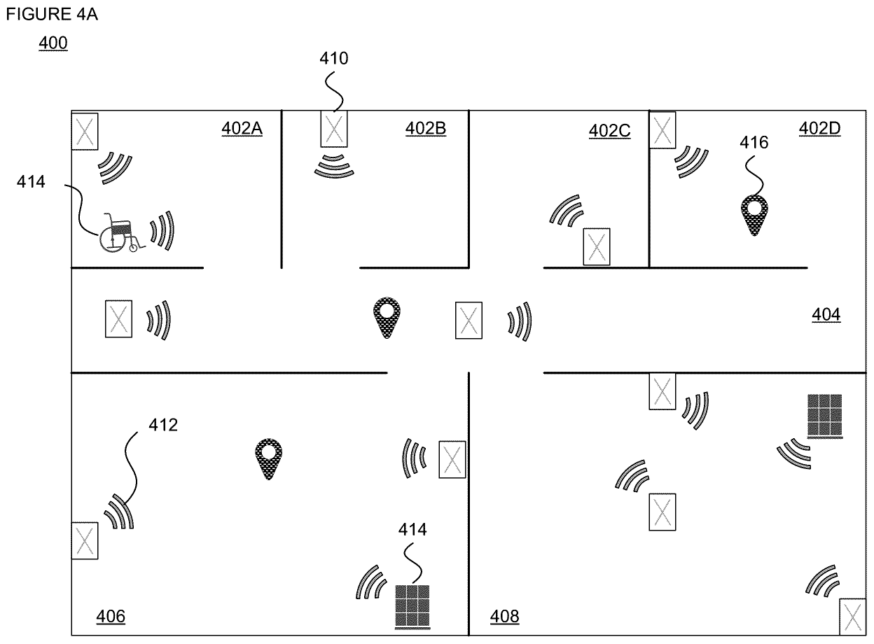

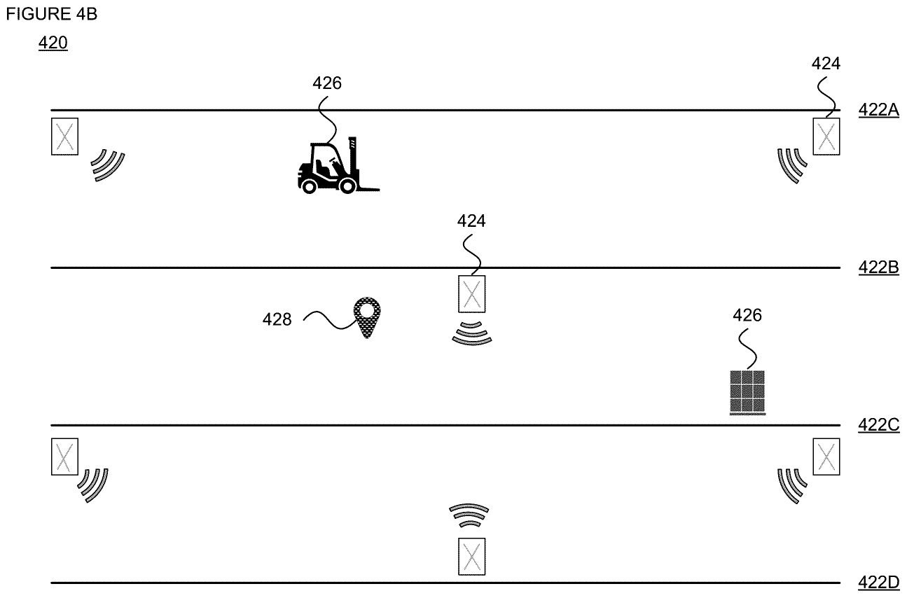

FIG. 4A illustrates one example 400 of a system having a number of tracking tags arranged in various locations of a building (e.g., a hospital). In this example, there may be a number of rooms 402A-402D, such as patient rooms, along one side of a hallway 404. On the opposite side of the hallway 404 there is a storage room 406, such as to house equipment or supplies, as well as another room 408, which may be a meeting room, common area, rehab facility or the like. One or more fixed tracking tags 410 corresponding to the tracking tags 102 or 104 may be located in each room, including the hallway. Each fixed tracking tag 410 is configured to emit beacon signals 412 (e.g., RF signals in a selected frequency band according to a particular communication protocol). While the beacon signals 412 may appear directional, this need not be the case and the beacon signals may be transmitted omnidirectionally, for instance from a tracking tag 410 that is located on the ceiling, pillar or floor. In some implementations, the tracking tag 410 may be configured to emit beacon signals with information associated with its environment (e.g., temperature, humidity, etc.).

Tracking tags 414 may correspond to tracking tags 102 or 104 when placed on a variety of objects (e.g., a case of supplies as shown in storage room 406 or a wheelchair shown in room 402A). In some instances, the tracking tags may also be configured to emit beacon signals with information associated with the object on which the tracking tag is applied (e.g., temperature, motion information, object details, and/or other detectable characteristics of the tracking device or its environment). Readers 416 may be found at various locations in the building, such as in a patient room, the storage room, the hallway or other location. Note that even if transmitted omnidirectionally, the beacon signals from a given tracking tag may be attenuated in a non-uniform manner due to the presence of walls, furniture, floors/ceilings, equipment, etc.

FIG. 4B illustrates another example 420 of a system having a number of fixed tracking tags positioned along different aisles in a warehouse setting. In this example, there are a number of aisles 422A-422D, although there may be more (or fewer) aisles, and the aisles may be arranged in other configurations than what is shown. Here, fixed tracking tags 424 are located at different places for the aisles, such as along aisle end caps, along the ceiling (or floor), on shelves, storage lockers, cabinets or other places along the aisle, etc. Similar to FIG. 4A, fixed tracking tags 426 are placed on or otherwise associated with different objects, such as a pallet of equipment or a forklift that retrieves items from their locations in the warehouse. As above, the fixed tracking tags are configured to transmit beacon signals that are detectable by one or more readers 428.

In order to determine the location of a given tracking tag, the system may use signal strength information obtained from the beacon signals of one or more tracking tags. A series of beacon signals may be ramped at different power levels (a ramped sequence). Evaluating the received beacon signals in view of their transmitted power can enable the system to determine which room or other location at which a given tracking tag is located. From that, the system is able to determine a location for a given tracking tag (and thus its corresponding object) with a suitable degree of certainty, such as by triangulating its position relative to the relevant tracking tags.

In order to enable the use of the aforementioned tracking tags on as many different types of objects and locations as possible, the tracking tags may be designed to be both thin and flexible. In addition, each tracking tag may be passive, such as a tracking tag configured to activate or be powered by environmental energy, or active, configured to include a battery or be coupled to another power source. In the case of a battery, delaying activation of the battery until the end user is ready to use the tracking tag is critical to extending the useful life of the tracking tag.

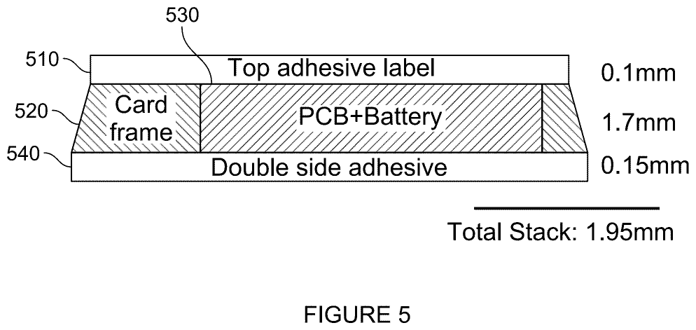

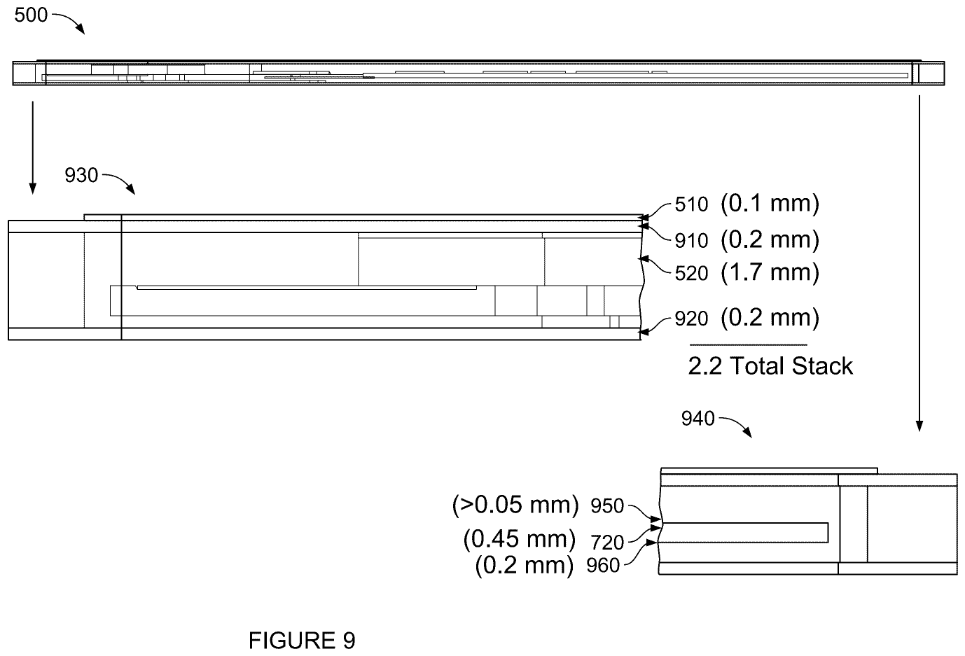

FIG. 5 is an example cross-sectional view of an example configuration of a tracking tag 500, which may be configured the same as or similarly to any of the tracking tags 102, 104, 410, 414 described above. In this example, the tracking tag 500 includes a top adhesive label 510, a frame 520, beacon transmission circuitry 530, and a double-sided adhesive 540. As shown, the configuration of the tracking tag 500 provides for a relatively thin form factor of approximately 1.95 mm. Although not depicted in FIG. 4, the tracking tag 500 may also include top and bottom covers 910, 920 discussed further below and depicted in FIG. 9 which may increase the overall thickness of the tracking tag 500.

The top adhesive label 510 may be a thin sheet (e.g., 0.1 mm) of polyester or paper with an adhesive backing which may be printed on during manufacturing and/or by the end user before application of the tracking tag on an object (e.g., an item, a wall, a shelf, etc.). For example, the end user may be able to print tracking and identifier information on the label and apply the label to a surface (e.g., the frame 520 or atop cover such as top cover 910 discussed further below) of the tracking tag 500 when ready to use the tracking tag. Such labels may include proprietary labels or commercially available labels such as those provided by AVERY including the Avery Ultra Duty White Film 94211. Similarly, the double-sided adhesive 540 may include commercially available glues or double-sided tapes such as those provided by 3M including 3M Double Coated Tape 93015LE. As depicted in FIG. 5, this double-sided adhesive 540 may have a thickness of approximately 0.15 mm.

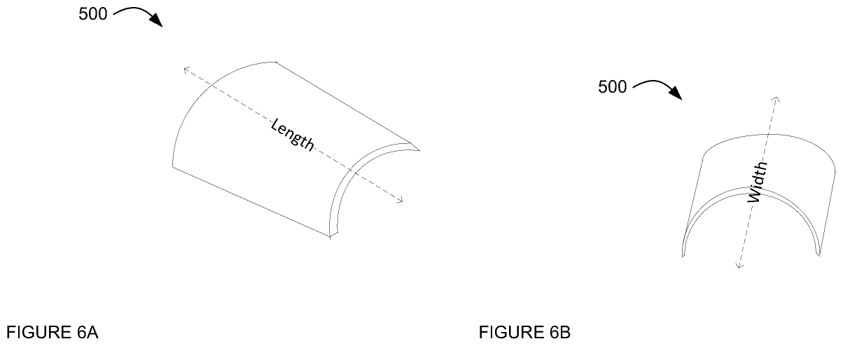

The frame 520 may be formed from various materials such as polycarbonates or other plastics such as cellulose fiber (paper/wood), polyethylene (PE/LDPE/HDPE), polypropylene (PP), Vinyl (PVC), Nylon, Polyurethane (foam), rubber, silicone, resin, carbon fiber. The frame may have a form-factor similar to a typical credit card of approximately 1.7 mm in thickness. The frame may be die-cut, molded or manufactured using other processes. The materials of the frame may be selected in order to enable the frame to be strong and puncture resistant while also flexible. In this regard, the frame may enable the tracking tag 500 to be attachable to objects (via the double-sided adhesive 540) of various shapes including curved surfaces, such as depicted in FIGS. 6A and 6B.

The PCB may be commercially available PCBs which can be connected to one or more batteries. For example, the PCB may include PCBs such as surface mount technology (SMT) PCBs including SMT white PCBs used in the i6 Ultra-thin Tag provided by MINEW or other such custom or commercially available devices that enable BLUETOOTH LE 4.0 technology for the purposes of enabling the aforementioned beacon signals.

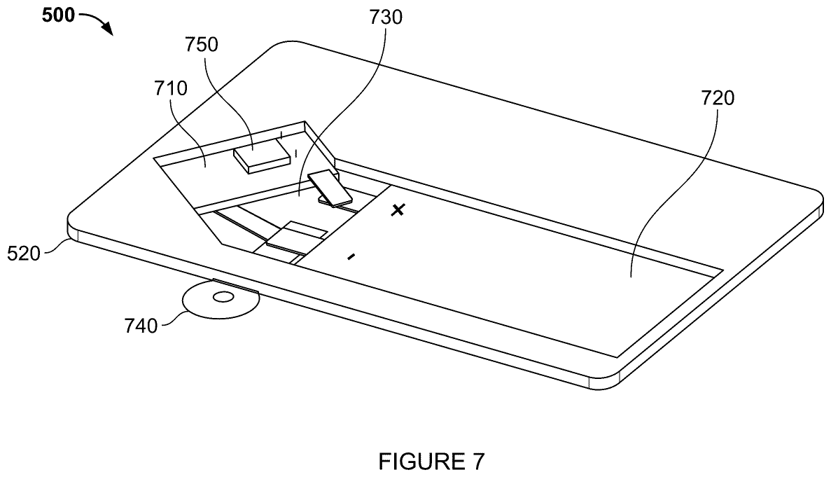

Turning to FIG. 7, a side-perspective view of the tracking tag 500 (without the top adhesive label 510), provides a view of beacon transmission circuitry arranged on a PCB 710 and one or more batteries 720 corresponding to the beacon transmission circuitry of FIG. 5. The PCB 710 may also include a beacon signal transmitter such as the aforementioned include identifier chip and/or a transmitting device in order to enable the tracking tag to provide beacon signals as well as one or more processors. For stability, the beacon transmission circuitry, including the PCB 710, the one or more batteries 720 as well as a processor 750, may be arranged on a backing 730. The backing 730 may be a thin, flexible polycarbonate sheet or any other substrate such as an RFID (Radio Frequency Identification) inlay or other feature sized to fit within the frame 520. Although not shown, in order to protect the PCB, circuitry, and battery, a cap sticker formed from puncture-resistant polycarbonate or other materials may be placed over an opening in the frame.

The processor 750 may be configured the same or similarly to processors 110 and may include conventional processors, such as commercially available CPUs. For instance, the processor may also include BLUETOOTH radio capabilities such as the NORDIC SEMICONDUCTOR nRF52832 or INPLAY IN100. In some instances, the processor 750 may actually comprise multiple processors that may or may not be stored within the same physical housing.

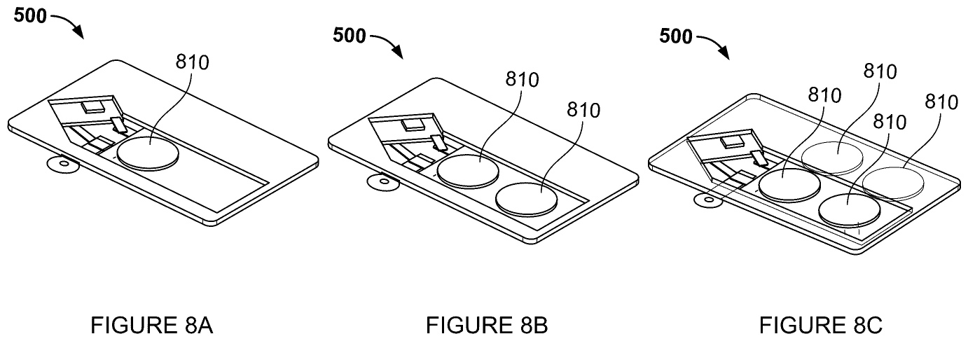

In this example, the one or more batteries 720 may be relatively thin. For example, the one or more batteries 720 may include a coin cell, [symbol] battery. For example, as depicted in FIG. 7, the one or more batteries 720 is a thin film battery. In this example, the thin film battery may be a commercially available thin-film CP0042350 battery provided by RENATA BATTERIES, etc. FIGS. 8A, 8B and 8C represent alternative example configurations of the tracking tag 500 with single coin cell battery 810 (FIG. 8A), a pair of coin cell batteries 810 (FIG. 8B), or four coin cell batteries 810 (FIG. 8C). The tracking tag 500 of FIG. 8C is shown in partial cross-sectional view order to depict all of the four coin cell batteries 810. In this example, CR2016 coin cell batteries are used, but in some alternative configurations other coin cell batteries, such as CR1216, CR1220, CR2012, etc. may be used. coin cell batteries are typically used in powered badges and key cards and provided various benefits such as improved safety (e.g., because of a metal encased battery with reduced puncture danger as compared to thin-film batteries), higher capacity or rather longer life for extended runtime operations, lower costs, easier storage (for example, coin cell batteries usually slot into a battery holder and thus can be stored separately and installed closer to time of use which may also allow tracking tags to be stored in facilities not rated for battery storage whereas flatpack or other custom batteries are typically bonded to the device at manufacturing), lower lead times (e.g., for manufacture and availability), and so on.

In addition, although coin cell batteries do not bend, their smaller form factor may allow for lower stiffness in the tracking tag. In other words, the tracking tag may be more tolerant to bending at points away from the coin cell battery whereas for a thin-film battery, bending should be avoided in order to prevent damage to the thin-film battery which may have a larger form factor. The further the ridged portions are located away from one another, such as the battery 720 (here, depicted as a thin-film battery) and the PCB 710, the greater the amount of flexibility that can be achieved. In this regard, given the configuration of the tracking tag 500, bending along the length of the tracking tag 500 as depicted in FIG. 6A may be less desirable (e.g., likely to cause damage to the rigid components) than bending along the width of the tracking tag 500 as depicted in FIG. 6B.

Returning to FIG. 7, the tracking tag 500 may also include an activation mechanism, here configured as a switch tab 740. For instance, an end user may press the switch tab 740 in order to connect the negative terminal of the one or more batteries 720 (or alternatively, a coin cell battery) with the PCB 710 via a copper (Cu) tape. This may activate the tracking tag 500 and initiate the transmission of the aforementioned beacon signals. In this example, the switch tab 740 may be a plastic pull tab, coated with a conductive grease such as LOCTITE LB 9008 C5-A and backed by a poron spring pad (not shown). In some instances, the switch tab 740 may be provided with a “press” icon or text in order to assist the end user in activating the tracking tag. Other approaches for battery activation are described further below.

FIG. 9 is a detail side cross-sectional view of the tracking tag 500 with the additional features of atop cover 910 and a bottom cover 920. FIG. 9 also includes detail views of opposing ends 930, 940 of the tracking tag 500. The top and bottom covers may be formed from polycarbonate or other plastics and may provide impact protection, prevent the ingress of liquids (e.g., water) and other contaminants, as well as provide a smooth surface for applying labels or on which to print information. In this example, the top cover 910 and bottom cover 920 may be approximately 0.2 mm thick, increasing the overall form factor of the tracking tag 500 to 2.2 mm. As such the tracking tag may have a very thin profile or thickness of less than 2.3 mm. In addition, the tracking tag 500 may be configured with an air gap 950 of at least 0.05 mm to allow for battery swell during operations as well as an adhesive 960, such as a conductive adhesive or double-sided tape, in order to hold the battery in place within the frame 520.

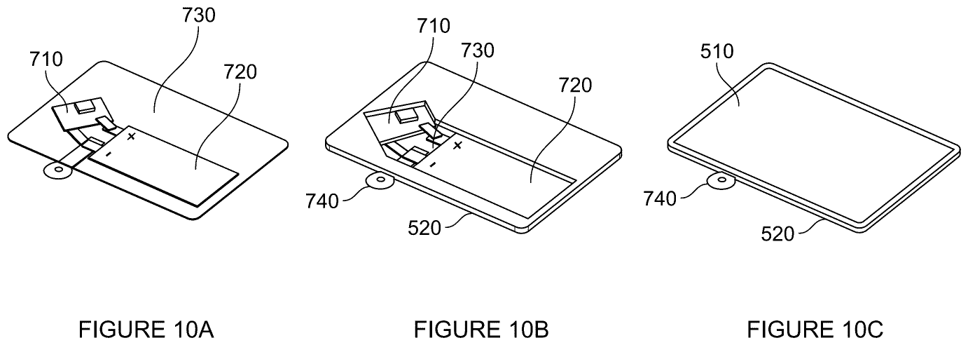

FIGS. 10A, 10B, 10C provide an example assembly process for the tracking tag 500. In this example, at FIG. 10A, the PCB 710 may be soldered to the one or more batteries 720 and the switch tab 740 to form a subassembly. The aforementioned conductive grease may also be applied to the switch tab 740. At FIG. 10B, the subassembly may be inserted into the frame 520, and the frame 520 may be attached to the bottom cover 920 (not shown). Finally, at FIG. 10C, the top cover 910 (not shown) may be attached. This assembly may be achieved using an assembly fixture-jig-template which may assist in locating and aligning parts, and an adhesive, such as double-sided tape, may be used to secure the components of the assembly to one another.

Although not shown, before use the tracking tag 500 may be attached to a liner sheet such as craft or other paper to protect the double-sided adhesive 540 before use. In this regard, before applying the tracking tag 500 to an object, this liner sheet may be removed (e.g., peeled away) from the tracking tag 500 in order to expose the double-sided adhesive 540. Thereafter the tracking tag 500 may be attached to an object.

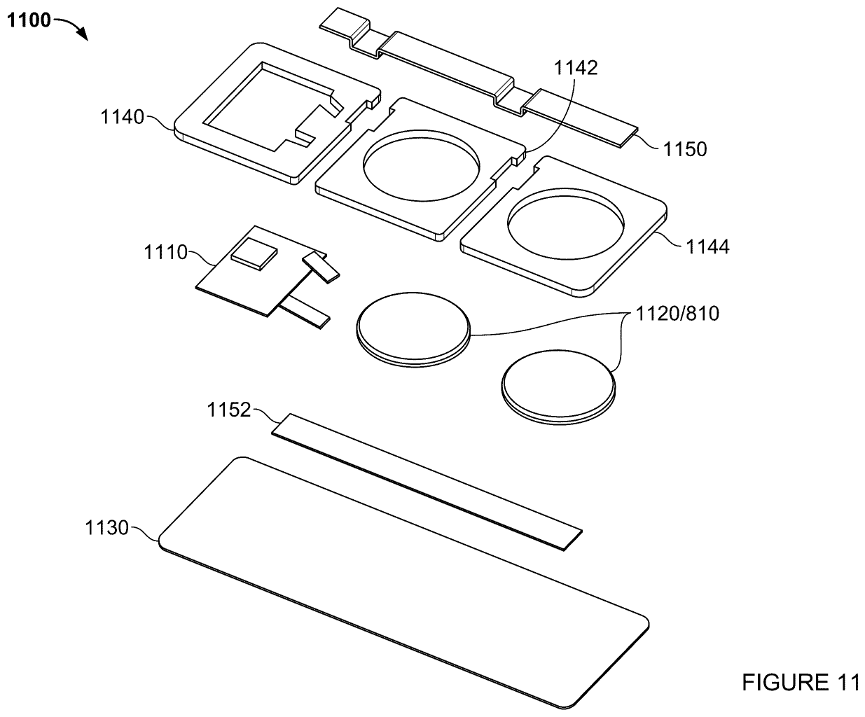

FIG. 11 provides an exploded view of a subassembly of a tracking tag 1100. In that regard, not all portions of the tracking tag 1100 are depicted in FIG. 11. The tracking tag 1100 may be configured similarly to the tracking tag 500 with a PCB 1110 (which may be the same as or similarly to the PCB 710) and one or more batteries 1120, here a pair of coin cell batteries 810, arranged on a backing 1130 (which may be configured the same as or similarly to the backing 730). In this regard, as with the tracking tag 500, the tracking tag 1100 may correspond to any of the tracking tags 102, 104, 410, 414.

However, rather than the configuration of frame 520, the tracking tag 1100 includes a plurality of subframes 1140, 1142, 1144 one to support each of the PCB 1110 and the one or more batteries 1120. As with the frame 520, the subframes 1140, 1142, 1144 may be formed from various materials such as polycarbonates or other plastics. The frames may be die-cut, molded or manufactured using other processes. Again, the materials of the frames may be selected in order to enable the frame to be strong and puncture resistant while also flexible. This configuration may promote wrap/bending applications in the correct or preferred direction (between the frames) and may provide for a relatively small footprint, for example, 23 mm in width by 85 mm in length (or about half the dimensions of the tracking tag 500).

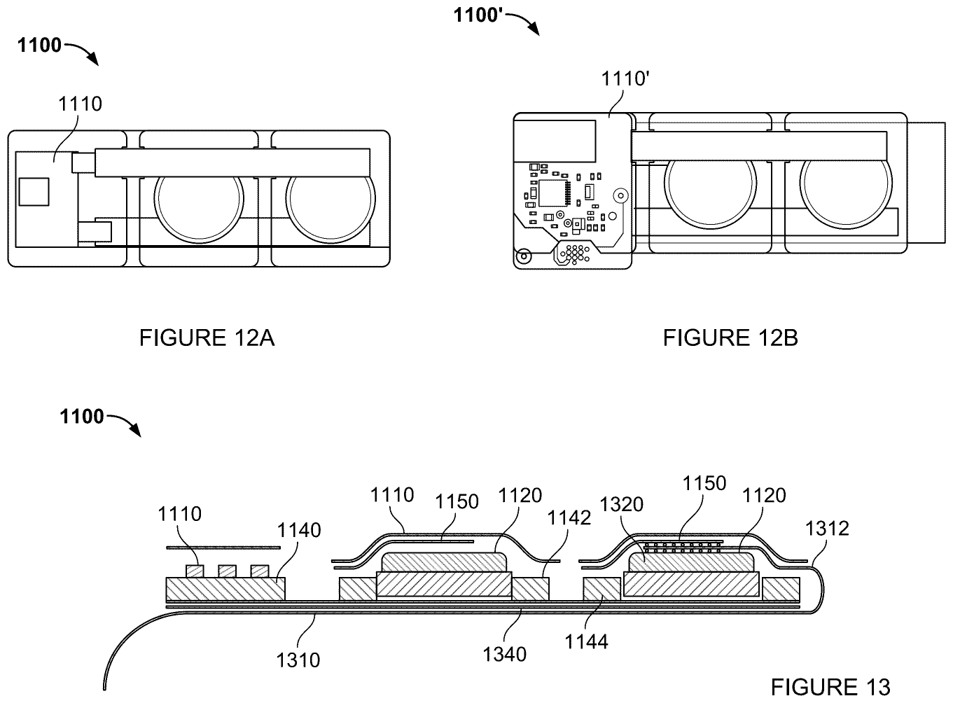

Although only three frames are depicted in FIGS. 11, 12A, and 12B and so on, additional frames and batteries may be added with additional batteries (with additional dedicated activation mechanisms if needed). In this regard, as the number of batteries increases, the number of frames may be increased.

As shown in FIG. 11, the positive contacts and negative contacts of the one or more batteries 1120 may be connected to the PCB 710 via copper tapes 1150, 1152 each with a layer of conductive adhesive to enable contact with the one or more batteries. Thus, as the number of batteries and frames increases, the length of the copper tapes may also increase to enable connections between the additional. The copper tapes may be secured to the positive terminal of the battery or PCB battery tab with a conductive pressure sensitive adhesive (PSA), and in some instances, conductive grease may also be applied to the negative terminal or PCB battery tab.

In some instances, as an alternative to the aforementioned batteries, additional frames may be configured with a deactivation strip (for privacy at end of operations of the tracking tag), additional PCBs using a different RF technology, additional sensors, etc. For example, the deactivation strip may allow for the physical breaking of the circuit including the one or more batteries and the PCB or other beacon transmission circuitry.

FIG. 12A provides a perspective view of the subassembly of the tracking tag 1100 with the PCB 1110 (as shown in FIG. 11), and FIG. 12B provides a perspective view of a subassembly of a tracking tag 1100′ which may be configured the same as or similarly to the tracking tag 1100 with an alternative PCB configuration, here PCB 1110′, for instance which may utilize a different beacon signal technology than PCB 1110 and/or different engagement and/or activation mechanisms.

As with the example of the tracking tag 500, the tracking tags 1100, 1100′ may be configured with various different types of activation mechanisms. FIG. 13 is an example partial cross-sectional view of the tracking tag 1100 (or tracking tag 1100′) with an activation mechanism configured as a liner sheet 1310 which includes a portion 1312 that wraps around and partially through the tracking tag 1100. In this example, the tracking tag 1100 is depicted in the pre-activation condition where the portion 1312 prevents the copper tape 1150 from contacting one 1320 of the one or more batteries 1120 and thereby preventing the one or more batteries from powering the PCB 1110. The liner sheet 1310 may be made from a liner sheet such as craft or other paper. By removing and pulling the liner sheet 1310 away from the tracking tag 1100 (not shown), in order to expose the double-sided adhesive 1340 (which may be configured the same as or similarly to the double-sided adhesive 540). In addition, the portion 1312 may also be pulled away from the one 1320 of the one or more batteries 1120 and copper tape 1150. A layer of conductive grease around the portion 1312 remains to facilitate the contact between the copper tape 1150 and the one or more batteries 1120, completing a circuit (e.g., beacon transmission circuitry) including the PCB 1110′ and the one or more batteries 1120.

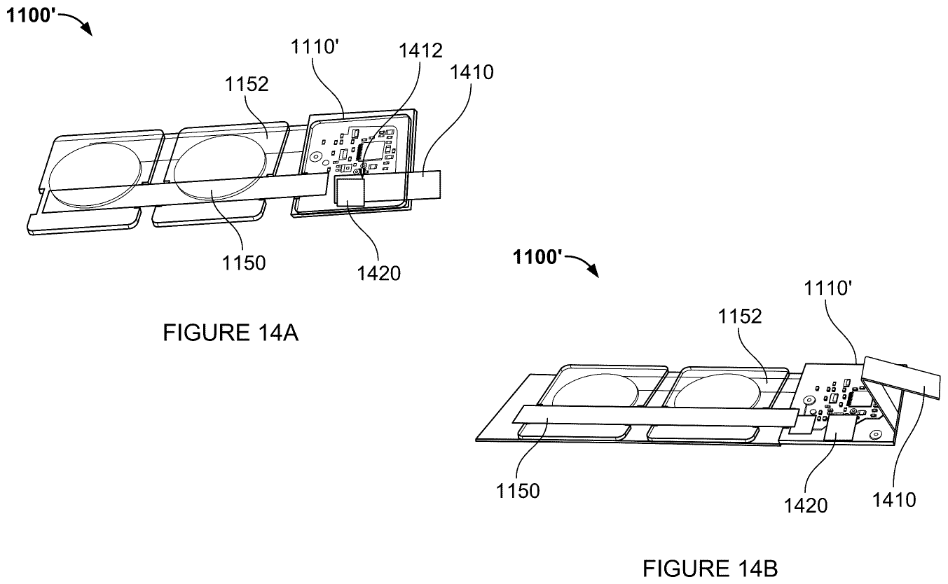

FIGS. 14A and 14B provide example perspective views of the subassembly of tracking tag 1100′ with an activation mechanism configured as a liner sheet 1410. In FIG. 14A, the liner sheet 1410 is arranged in the pre-activation condition where a portion 1412 of the liner sheet 1410 (under a copper tape 1420) prevents contact between the copper tape 1420 and the one or more contacts on the PCB 1110′. In this example, the copper tape 1420 may also be connected with the copper tape 1152. Turning to FIG. 14B, the tracking tag 1100′ is arranged in the activated condition where the pull tab 1410 has been removed. This enables contact between the copper tape 1420 and the PCB 1110′ thus completing a circuit (e.g., beacon transmission circuitry) including the PCB 1110′ and the one or more batteries 1120. This may then activate the tracking tag 1100′ and initiate transmission of the aforementioned beacon signals.

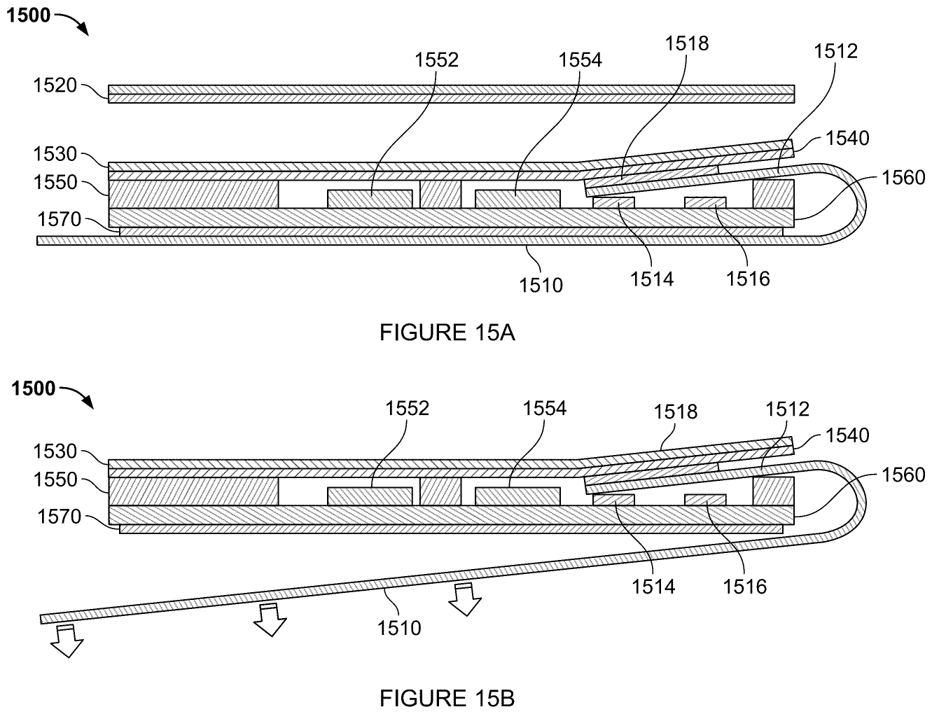

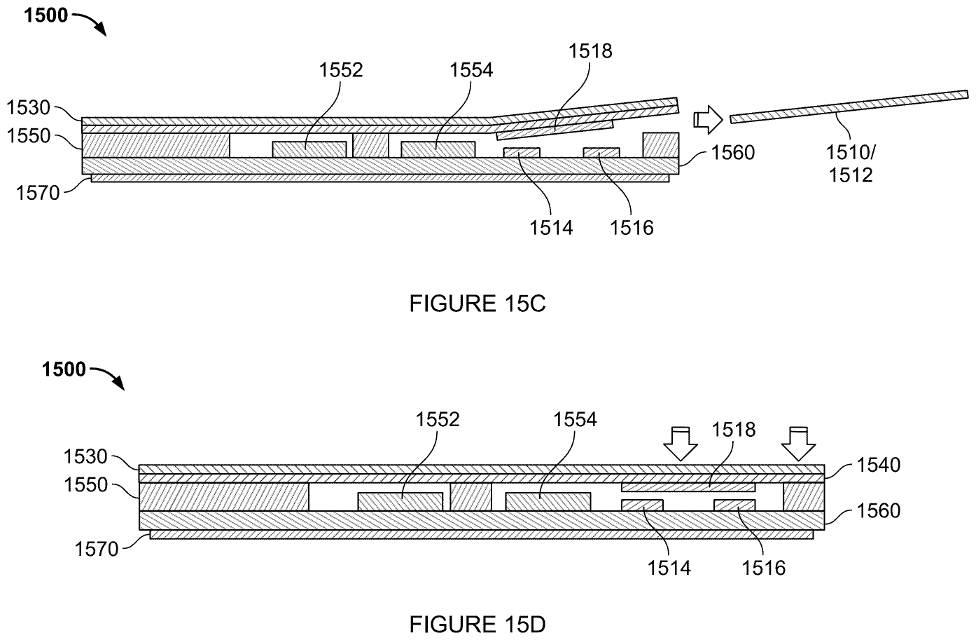

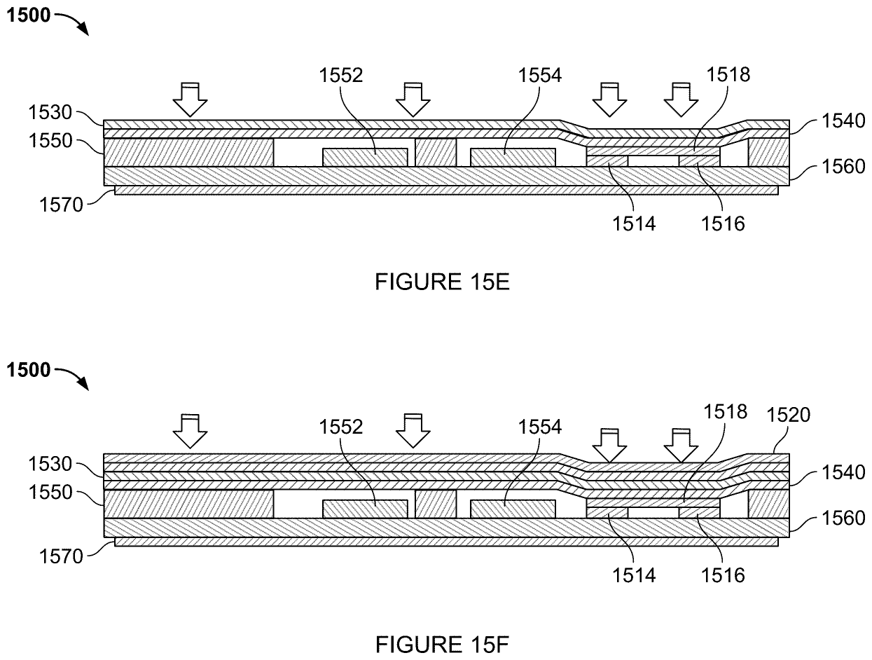

FIGS. 15A, 15B, 15C, 15D, 15E and 15F provide cross-sectional views of a tracking tag 1500, another activation mechanism, and a process for activating the tracking tag 1500. Tracking tag 1500 may correspond to any of the tracking tags 102, 104, 410, 414. Tracking tag may be configured similarly to the tracking tags 500, 1100, with a top adhesive label 1520 (shown as two layers corresponding to the label and adhesive and which may also correspond to the top adhesive label 510, 1350), a top cover 1530 (which may be configured the same as or similarly to the top cover 910) with an adhesive layer 1540 of conductive PSA or another adhesive, a frame 1550, a PCB 1560 (which may be configured the same as or similarly to the PCBs 710, 1110, 1110′), and a double-sided adhesive 1570 (which may be configured the same as or similarly to the double-sided adhesive 540).

The frame 1550 may be formed from various materials such as polycarbonates or other plastics and may have a form-factor sized to accommodate the depth or thickness of various chips 1552, 1554 or other devices arranged on the PCB in order to provide an added layer of protection for such chips or devices. The frame may be die-cut, molded or manufactured using various other processes. The materials of the frame may be selected in order to enable the frame to be strong and puncture resistant while also flexible. In this regard, the frame may enable the tracking tag 1500 to be attachable to objects (via the double-sided adhesive 1570) of various shapes including curved surfaces, such as depicted in FIGS. 6A and 6B.

In this example, the activation mechanism involves a liner sheet and separate copper contacts. As shown in FIG. 15A, a liner sheet 1510 includes a portion 1512 that wraps around a portion of the tracking tag 1500 and initially prevents contact between the copper contacts 1514, 1516 arranged adjacent to copper tape 1518. The liner sheet 1510 may be made from a liner sheet such as craft or other paper. While FIGS. 15A and 15F includes the top adhesive label 1520 shown over the tracking tag 1500, this top adhesive label 1520 is not depicted in FIG. 15B, 15C, 15D, 15E or 15F for simplicity.

Turning to FIG. 15B, the liner sheet 1510 may be removed from the tracking tag 1500 exposing the double-sided adhesive 1570. By removing and pulling the liner sheet 1510 away from the tracking tag 1500, the portion 1512 may also be pulled away from the copper contacts 1514, 1516 and copper tape 1518 as shown in FIG. 15C. A layer of conductive adhesive, such as conductive PSA, on the copper tape 1518 may naturally cause contact between the copper contacts 1514, 1516 and the copper tape 1150 as shown in FIG. 15D and thereby completing a circuit including the PCB 1560 and one or more batteries (not shown) such as the one or more batteries 1120. As an alternative to the conductive adhesive, conductive grease may be used.

However, to ensure this contact is secure, the end user may apply a force on the top cover 1530 (which may be configured the same as or similarly to the top cover 910) at a location above the copper tape 1518 to and the copper contacts 1514. This force may compress the top cover 1530 against the frame 1550 as shown in FIG. 15E. This, in turn, may cause the copper tape 1518 to compress against the copper contacts 1514, 1516 causing the conductive adhesive to form a secure bond and contact between the copper tape 1518 to and the copper contacts 1514, 1516. Thereafter, as shown in FIG. 15F, the top adhesive label 1520 may be applied to the tracking tag 1500 by an end user. This action by the end user may provide additional confirmation that there is contact between the copper tape 1518 to and the copper contacts 1514, 1516.

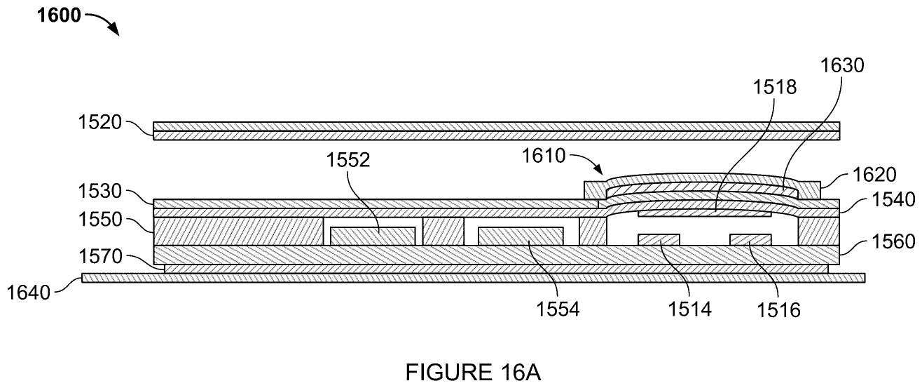

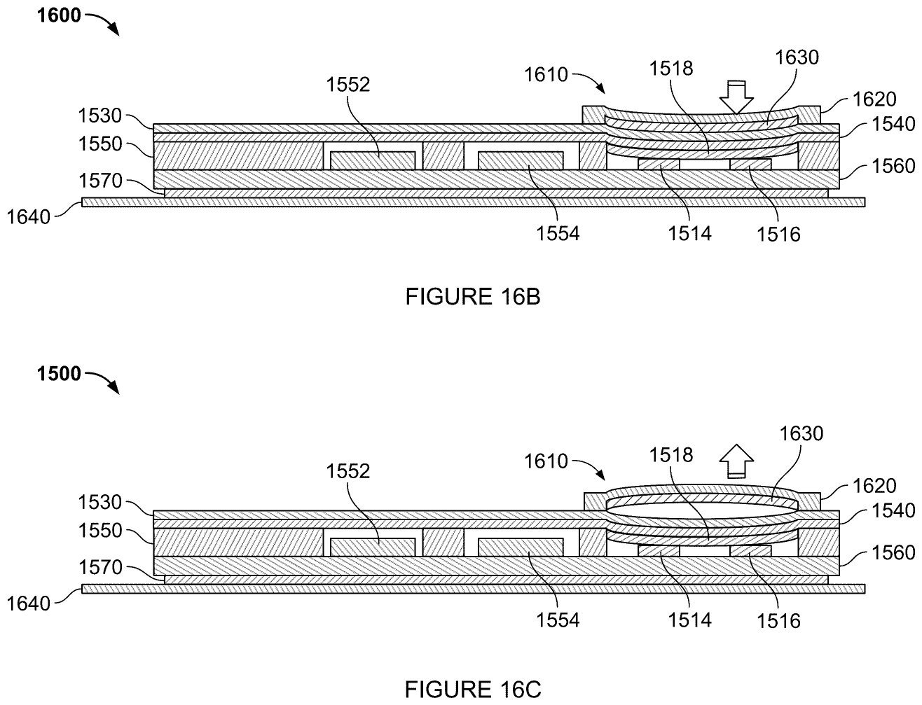

FIGS. 16A, 16B, 16C provide cross-sectional views of the tracking tag 1600 and another activation mechanism and process for activating the tracking tag 1600. In this example, tracking tag 1600 may generally correspond to the tracking tag 1500, including the top adhesive label 1520 (not shown in FIGS. 16B and 16C for simplicity), the top cover 1530 with an adhesive layer 1540, the frame 1550, the PCB, the double-sided adhesive 1570, as well as the copper tape 1518 to and the copper contacts 1514, 1516. The activation mechanism involves a button 1610 including a mylar sticker 1620, a metal dome 1630 over the metal dome, and copper contacts 1514, 1516. The mylar sticker may include an icon or text to indicate to the end user that the button 1610 must be pressed downward to activate the tracking tag 1600. In this regard, in FIG. 16A, the tracking tag 1600 is shown in the pre-activated condition where the button 1610 has not yet been compressed. In this example, the tracking tag 1600 also includes a liner sheet 1640 such as craft or other paper to protect the double-sided adhesive 1570 before use.

Turning to FIG. 16B, the end user may apply a force on the button 1610 which is arranged above the copper tape 1518 to and the copper contacts 1514. This force may compress the button 1610 which includes the mylar sticker 1620 and the metal dome 1630 against the top cover 1530. This may compress the top cover 1530 against the subframes 1142, 1140. This, in turn, may cause the copper tape 1518 to compress against the copper contacts 1514, 1516 causing the conductive adhesive to form a secure bond and contact between the copper tape 1518 to and the copper contacts 1514, 1516 and completing a circuit (e.g., beacon transmission circuitry) including the PCB 1560 and one or more batteries (not shown) which may be configured the same as or similarly to the one or more batteries 720, 1120 or coin cell batteries 810.

As shown in FIG. 16C, once the force is removed from the mylar sticker 1620 and metal dome 1630, the metal dome 1630 may spring back away from the top cover 1530. If the connection is not achieved, the force may be applied on the mylar sticker 1620 and metal dome 1630 again. Thereafter, the top adhesive label may be applied to the tracking tag 1600, for example as depicted in the example of FIG. 15F. In this regard, the top adhesive label may cover the mylar sticker and the metal dome. In some instances, the top adhesive label may include a button icon or text to reveal the dome location, if desired.

As noted above, the tracking tags described herein, such as any of tracking tags 102, 104, 410, 414, 500, 1100, 1100′, 1500, 1600, may include activation mechanisms for activating the tracking tags in order to complete a circuit (e.g., beacon transmission circuitry) including the one or more batteries and PCB in order to initiate the aforementioned beacon signals. In this regard, the activation mechanisms described above may be only examples, and different activation mechanisms may be used with any of tracking tags 102, 104, 410, 414, 500, 1100, 1100′, 1500, 1600 such as the various activation mechanisms described in more detail below. For instance, the activation mechanism may include an initially open circuit until the tracking tag is activated or an initially closed circuit until the tracking tag is activated. In this regard, an initially closed circuit may require coordination with a hardware load switch with a disable function or firmware detection to wake from a hibernation state (e.g., deep sleep).

These various different activation mechanisms may be combined with different engagement mechanisms. For instance, while an activation mechanism may be used to activate a tracking tag, an engagement mechanism for a circuit (e.g., beacon transmission circuitry) may be used in order to maintain the connections in the circuit once the tracking tag is activated. For example, the engagement mechanisms may include mechanical latching to physically maintain the activated or on state of the circuit or circuit latching which uses an additional electrical circuit to maintain the activated or on state of the circuit.

One example engagement mechanism may include a mechanical latching mechanism or a physically latching switch. For instance, mechanical latching mechanisms may involve mechanical latches including cam latches (e.g., which may involve a rotating cam with a pin and spring), draw latches, gate latches, ball spring mechanisms, leaf spring buttons and so on. A mechanical latching mechanism may cause a force opposing the reaction (e.g., closing or opening a switch) once the mechanical latching mechanism is activated. Switches can have very simple designs (e.g., a simple switch) with no power drain prior to activation of the tracking tag. However, there may be limited options for lower profile switches to be used in the tracking tags described herein.

Another example engagement mechanism may include an electrically latching mechanism. Example electrically latching mechanisms may include, for example, Silicon Controlled Rectifier (SCR) circuits, metal-oxide-semiconductor field-effect transistor (MOSFET) turn-on circuits (aka soft power latching circuit), relay or solid-state relay (SSR) circuits, e-fuse or antifuse devices, etc. An SCR circuit may include an anode, a cathode and gate arranged in various configurations to control load current flow. These configurations may allow for “normally open circuit” designs which may not allow the flow of current through the circuit including the one or more batteries and the PCB until activated. This may allow for greater design flexibility though may result in a small power drain prior to the activation of the tracking tag as well as during operation (i.e., an additional power drain while the beacon signals are being sent).

Another example engagement mechanism may include a normally closed circuit which may allow the flow of current through the circuit including the one or more batteries and PCB of a tracking tag. In this regard, the normally closed circuit is activated by creating an open circuit which acts as a 0-ohm connection during operation of the tracking tag (i.e., after activation). For example, such an engagement mechanism may be used with the switch tab 740 described above. Such a configuration may provide for very simple designs but may likely require a small current draw prior to activation of the tracking tag but no power draw after activation (as the normally closed circuit would now be broken).

One example activation mechanism may include a non-mechanical switch. Non-mechanical switches may include, for example, thermal switches which involve two different metals clad together that change shape as temperature changes and can be integrated into electrical circuits. For instance, a thermal switch may include a bimetal or two phase (solid-liquid-solid) connection such as a low temp solder that intentionally reflows and bridges a circuit. In this regard, a thermal switch could be activated manually by an end user applying heat to the tracking tag or automatically via heat applied to the tracking tag during the label printing process itself, from a focused laser source, or from another separate heat source. Thermal switches may be combined with engagement mechanisms such as SCRs with normally open circuits or normally closed circuits and/or may involve mechanical latching mechanisms. However, thermal switches may require a very limited temperature range for activation, the need to avoid premature activation from external heat sources, and may require further technological development for useful application in such instances.

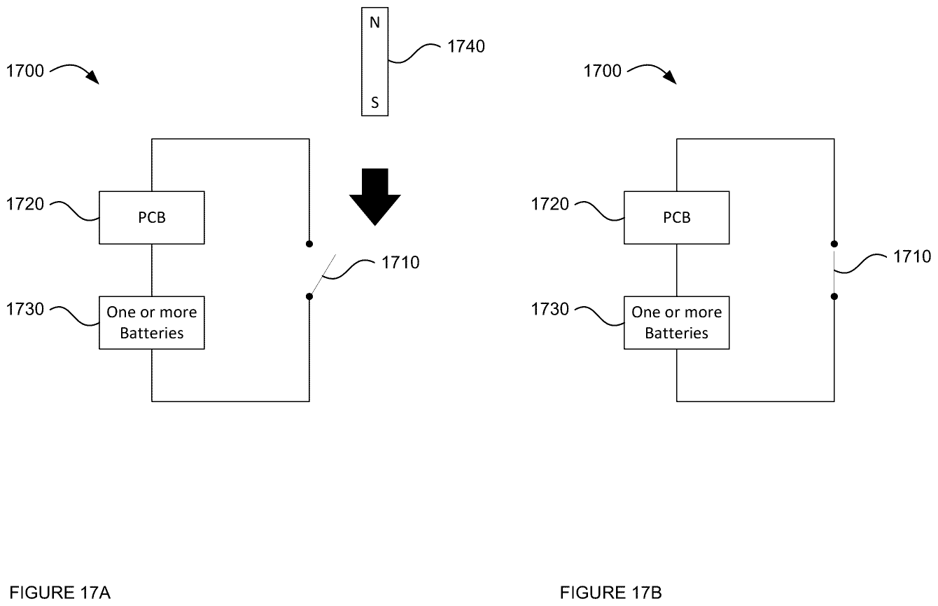

Other non-mechanical switches may include magnetic switches. For example, a magnetic switch may include a reed switch or0 a non-latching magnetic switch combined with an SCR. As an example, an SCR can stay “on” even if the magnetic switch reverts due to mechanical shock, and will stay active until voltage drops below a threshold such as when the battery is dead. Various configurations of the reed switch may be used, including for example, normally open (NO) contacts with single pole single throw (SPST) activation, normally closed (NC) contacts with SPST activation, a changeover with single pole double throw (SPDT) activation, or bistable contact configuration. The magnetic switch may be activated manually by an end user with a magnet (e.g., by moving a magnet near the magnetic switch) or automatically by moving the tracking tag through a magnetic field. For example, FIGS. 17A and 17B provide a simplified representation of a reed switch 1710 of a circuit 1700 (e.g., beacon transmission circuitry) that includes a PCB 1720 and one or more batteries 1730 which may be configured the same as or similarly to the PCB 710, 1110, 1110′, 1560, and one or more batteries 720, 1120 or coin cell batteries 810, respectively, of the tracking tags 102, 104, 410, 414, 500, 1100, 1100′, 1500, 1600. By moving magnet 1740 across the reed switch 1710, this may cause the reed switch to move from the open condition depicted in FIG. 17A to the closed condition depicted in FIG. 17B. In some instances, a tracking tag with a magnetic switch may be automatically activated by moving the tracking tag through a magnetic field after completing the printing processes discussed below. Magnetic switches may be combined with engagement mechanisms such as SCRs with normally open circuits or normally closed circuits and/or may involve mechanical latching mechanisms. Magnetic switches may provide simplified and reliable operations which can be activated manually or automatically. However, magnetic switches with glass shells may be prone to breaking and there may be limited options for magnetic switches small enough (e.g., 2 mm in diameter or less) to be used in the tracking tags described herein.

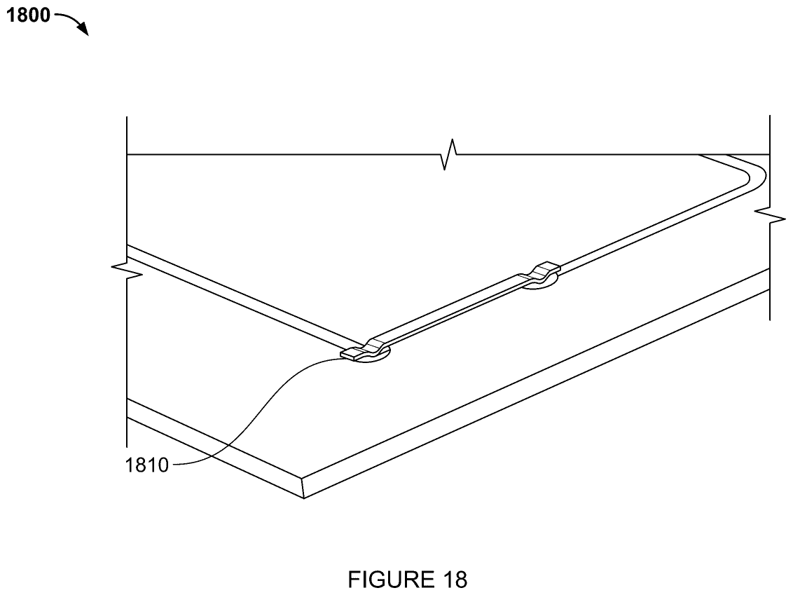

Another example activation mechanism may include a removable bridge. For example, a small conductive bridge may be used to short an SCR or similar circuit until a tracking tag is activated. FIG. 18 provides an example representation of a bridge 1810 arranged on a tracking tag 1800 (shown in partial view), which may be configured the same as or similarly to the tracking tags 102, 104, 410, 414, 500, 1100, 1100′, 1500, 1600. Once the bridge is removed, the SCR or similar circuit may activate the tracking tag and initiate the transmission of the aforementioned beacon signals. In such configurations, the bridge may be held in place in a pre-activated condition by a liner sheet such as craft or other paper used to protect the double-sided adhesive prior to use of the tracking tag. In this regard, the liner sheet may be similar to the liner sheets 1310, 1510, 1640 described above. In this example, when the liner sheet is removed in order to expose the double-sided adhesive, the bridge may stick to the liner sheet and also be removed, activating the tracking tag and initiating the transmission of the aforementioned beacon signals. Removable bridges may be combined with engagement mechanisms such as SCRs with normally open circuits or normally closed circuits. Removable bridges may be extremely thin, may be relatively low cost to produce or purchase, and may not require additional steps for an end user to activate the tracking tag. However, removable bridges may require some small power drain on the tracking tag prior to activation of the tracking tag, and may also require significant engineering efforts to ensure reliable operations.

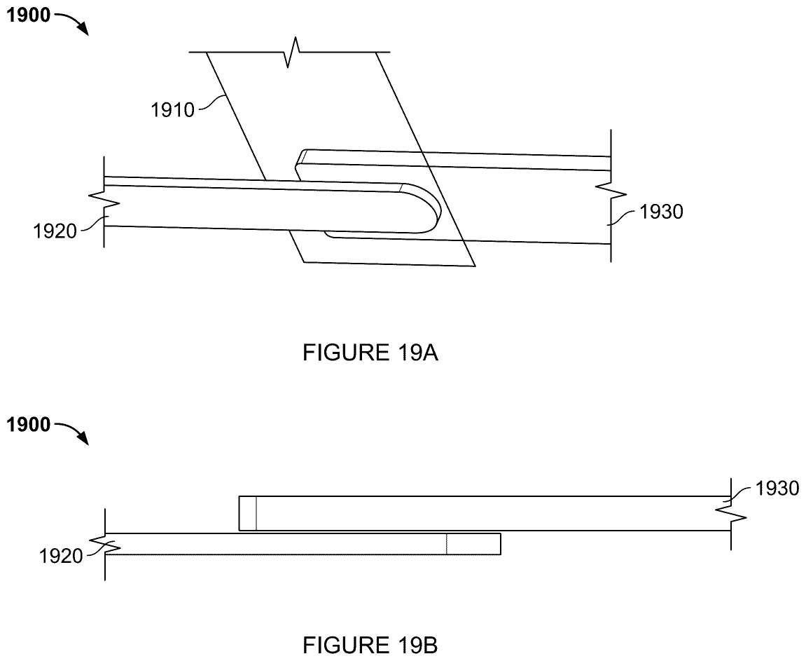

Another example activation mechanism may include a pull tab. Pull tabs may be used with mechanically latching or other naturally latching designs. A pull tab may include a physical insulator that creates an open circuit between two conductors. As such, the circuit may be closed when the pull tab is removed from between the two conductors. For example, FIGS. 19A and 19B provide a simplified example representation of a pull tab 1910 in a circuit 1900 (e.g., beacon transmission circuitry shown in partial view) that includes a PCB (not shown) and a plurality of batteries (not shown) which may be configured the same as or similarly to the PCB 710, 1110, 1110′, 1560, and one or more batteries 720, 1120 or coin cell batteries 810, respectively, of the tracking tags 102, 104, 410, 414, 500, 1100, 1100′, 1500, 1600. As shown in FIG. 19A, the pull tab 1910 is arranged between two circuit portions 1920, 1930 of the circuit 1900, and the circuit 1900 is not yet completed. By removing the pull tab 1910, this may cause the circuit portions 1920 and 1930 to engage one another as depicted in FIG. 19B there by completing the circuit 1900. Such configurations may also be used with engagement mechanisms such as those that may involve magnetic latching, spring forces which may or may not be bonded with thermal grease (which may pose reliability concerns), or with an additional latching mechanism such as an SCR such as where the pull tab is only a momentary activation so the additional latching mechanism maintains the connection. Pull tabs may be combined with engagement mechanisms such as SCRs with normally open circuits or normally closed circuits. As an example, the portions 1312, 1412 of the liner sheets 1310, 1410, respectively, described above may function as pull tabs. Pull tabs may provide simple, cost-effective designs with no power drain prior to activation. Pull tabs may allow for manual activation of the tracking tag by the end user by simply pulling on the tab. However, in some instances, a pull tab may even be removed automatically during the printing process in order to limit interaction by the end user.

Another example activation mechanism may include a mechanical button. A mechanical button may include a small PCB or frame-mounted button (such as button 1610 described above) or a leaf-spring bridge. As described above, a mechanical button, such as button 1610, may be activated manually by an end user applying a force on the button and/or passively via applying pressure during label attachment. In some instances, a force may be applied on the button automatically during the label application process in order to eliminate end user interaction with the button. Mechanical buttons may be combined with engagement mechanisms such as SCRs with normally open circuits or normally closed circuits and/or may involve mechanical latching mechanisms. Mechanical buttons may provide simple, cost-effective designs with no power drain prior to activation. However, mechanical buttons may provide for limited options for smaller activation dimensions because of the physical distance needed to activate the button (e.g., travel room) in order to minimize the thickness of the tracking tag.

Upon activation and intuition of transmission of the aforementioned beacon signals, the tracking tags described herein may provide some assurance that the tracking tag is active and transmitting the aforementioned beacon signals. This may be achieved by including an LED which flashes at a very slow rate, a buzzer, accessing details from the storage system 250 (e.g., which may provide estimated battery life based on when the tracking tag was first registered, and presumably, activated), or other visual changes (such as a rotating or color changing tag, etc.).

As noted above, in addition to activation of the tracking tags, the top adhesive labels, such as top adhesive labels 510, 1350, 1520, may need to be printed and applied to various objects for tracking and/or other types of monitoring of these objects. Different approaches for printing top adhesive labels, applying top adhesive labels, registering the tracking tags, activating the tracking tags, and attaching the tracking tags to an object or “provisioning processes” may be used. During the registration part of this provisioning process, information such as tracking tag identifiers, tracking numbers, as well as information about the objects themselves, such manufacturing data (e.g., manufacturing date, serial number, etc.) may need to be registered with the one or more server computing devices 108 in order to enable information about the object to be tracked in the storage system 250. To facilitate this, as indicated above, each tracking tag may be assigned a unique identifier, for instance, via listening on BLE air, using RFID, NFC, QR codes, or other software interaction. Some of these methods lend themselves to readability with generally available equipment (e.g., QR codes) while others may require more specialized equipment which may increase costs.

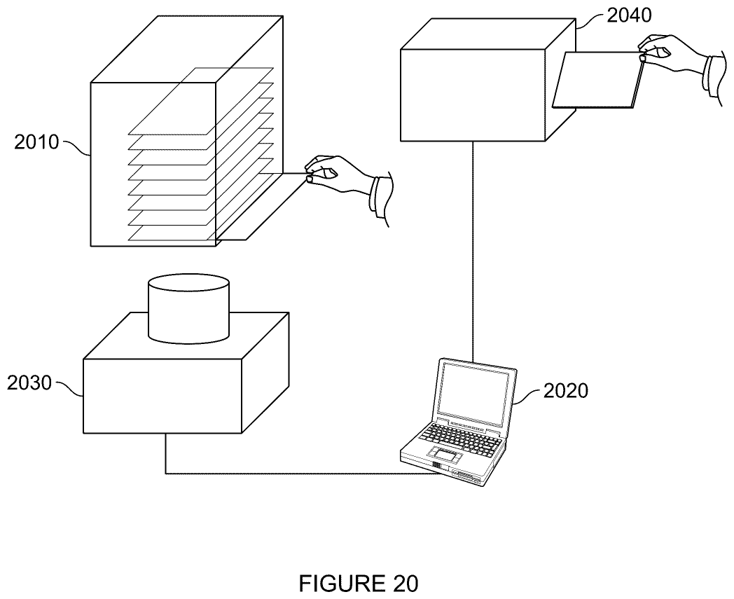

Preferably, the steps of the provisioning process are performed at about the same time. In other words, the printing, application, registering, activating and attachment steps occur generally at the same time, for instance in some sort of organized sequence, although they may occur in various different orders (e.g., activation may occur before or after the top adhesive label is applied). The simplest, but most time-consuming and costly provisioning processes may involve a completely manual process as represented by the functional diagram of FIG. 20. In this example, the tracking tags may be arranged on a roll or accordion style (as shown) in a card hopper 2010. The end user may retrieve a tracking tag (e.g., from card hopper 2010), input the adhesive label into printer 2040 (e.g., a fully equipped printing device or a printer head) and input the tracking tag's identifier into a tracking tag application using a client computing device 2020 which may correspond to one of the client computing devices 220, 230, 240. This may be achieved by an input device 2030, which may include a camera, barcode scanner, QR code scanner, RFID reader, NFC reader, or other visual, mechanical, electronic, or RF input device. In this regard, the input device 2030 may capture data from a QR code, bar code, RFID, NFC, etc. of the tracking tag. For instance, the tracking tag may have a visual code printed on the frame or may include a passive RFID or a no power NFC chip, etc. which can be read by the input device.

The user may then also assign or identify a unique identifier (e.g., a tracking number) for the object to which the tracking tag will be applied and associate this unique identifier with the tracking tag identifier in the tracking tag application (“pairing”). This association may be stored, for instance by the one or more server computing device 108 in the storage system 250, thereby registering the tracking tag.

The printer 2040 may also be in communication with the computing device 2020 enabling the computing device 2020 to provide the printer with the information identifying the unique identifier for an object and the tracking tag identifier. The printer 2040 may then be used to print a top adhesive label (such as top adhesive labels 510, 1350, 1520). The printed top adhesive label may therefore include information identifying the tracking tag identifier and associated unique identifier. The user may then apply the top adhesive label to the tracking tag, activate the tracking tag, remove a liner sheet from the tracking tag to expose double-sided adhesive (as in the examples described above), and apply the tracking tag to the object.

This approach may also require that the end user verify activation of the tracking tag. For instance, this may involve verifying that the tracking tag is operational (e.g., transmitting the aforementioned beacon signals) with sufficient battery life to ensure successful operation for a desired period of time. For example, the end user may look for a flashing light, buzzer or use some other device to confirm that the tracking tag is transmitting the aforementioned beacon signals. In addition, if the end user is provisioning hundreds or even thousands of tracking tags a day, the manual approach may become unworkable and potentially prone to human error at each of the various steps.

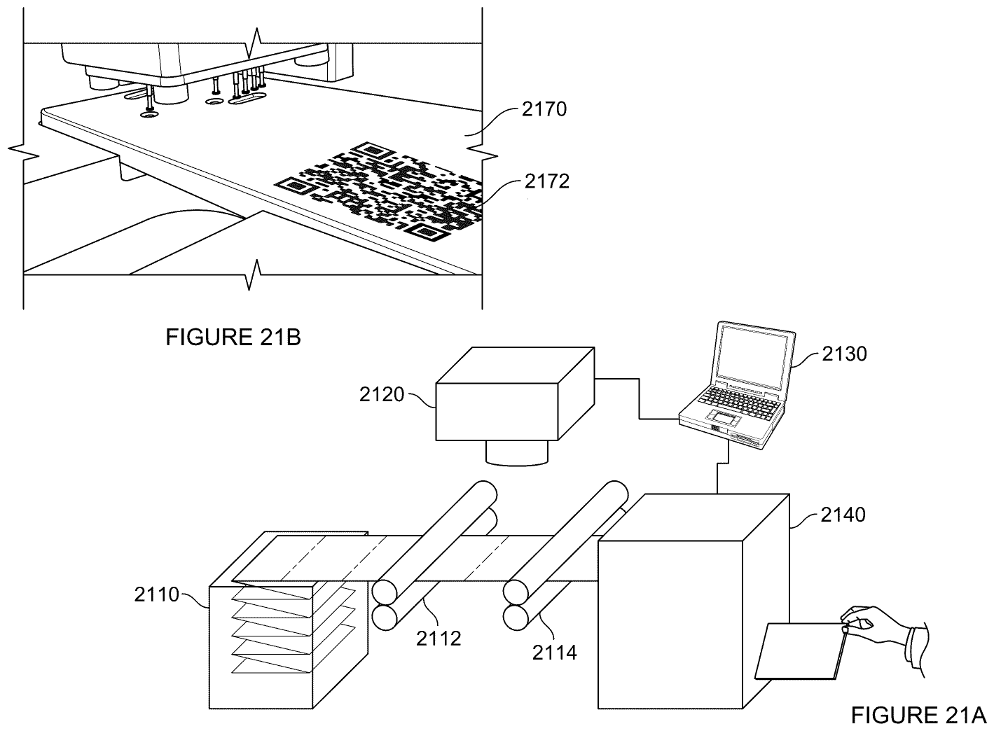

Some steps of the provisioning process may be automated using various systems in order to reduce or even eliminate human involvement and streamline the provisioning process. For example, FIG. 21A represents a process for automating some of the steps of the provisioning process. In this example, tracking tags with pre-printed visual codes such as QR codes or barcodes may be arranged on a roll or accordion style (as shown) on a single longer, and in some cases periodically perforated, liner sheets in the card hopper 2110. For example, FIG. 21B is an example perspective view of a tracking tag 2170, which may be configured the same as or similarly to any of the tracking tags 102, 104, 410, 414, 1100, 1100′, 1500, 1600, includes a pre-printed QR code 2172. This pre-printing of visual codes may be a part of the manufacturing process for the tracking tags as discussed further below, and each visual code may be printed on a top adhesive label again applied during the manufacturing process. Each visual code may embed the tracking tag identifier for the particular tracking tag on which the code is printed. The tracking tags may be pulled out of the hopper and adjacent to an input device 2120 via one or more rollers 2112, 2114 or other devices.

The input device 2120 may automatically scan the pre-printed visual codes on the tracking tags in order to read the pre-printed visual codes and identify the tracking tag identifiers. In this regard, as with the input device 2030, the input device 2120 may include a camera, barcode scanner, QR code scanner, RFID reader, NFC reader, or other visual, mechanical, electronic, or RF input device. Thus, the input device 2120 may capture data from a QR code, bar code, RFID, NFC, etc. of the tracking tag. The input device may provide the identified tracking tag identifiers to a computing device 2130, which may correspond to one of the client computing devices 220, 230, 240. The user may then also assign or identify a unique identifier (e.g., a tracking number) for the object to which each tracking tag will be applied and associate this unique identifier with the tracking tag identifier in the tracking tag application. This association may be stored, for instance by the one or more server computing device 108 in the storage system 250, thereby registering the tracking tag.

After the scanning by the input device 2120, the one or more rollers 2112, 2114 or other devices may cause the tracking tags to enter into a printer 2140 (e.g., a fully equipped printing device or a printer head). The printer 2140 may also be in communication with the computing device 2130 enabling the computing device 2130 to provide the printer with the information identifying the unique identifier for an object. The printer may then print the information on the tracking tag, for example, at a location distinct from the pre-printed QR code in order to prevent overwriting. The printer may also include a cutting device (not shown) in order to separate the tracking tags. The user may then activate the tracking tag, remove a liner sheet from the tracking tag to expose double-sided adhesive (as in the examples described above), and apply the tracking tag to the object associated with the tracking tag identifier of the tracking tag.

While this approach may cut down on some of the end user's manual efforts, the end user may still be required to verify activation of the tracking tag as described above. The end user must also apply the tracking tags to the objects manually.

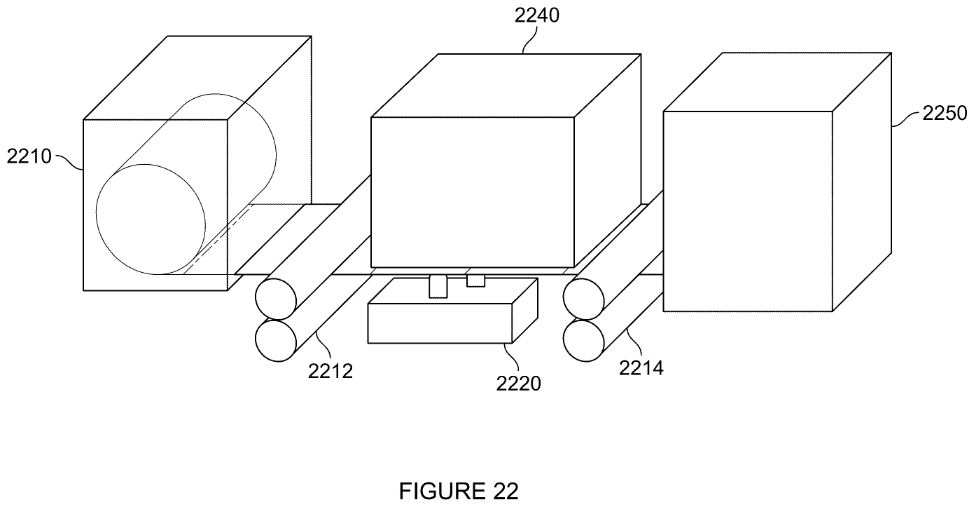

FIG. 22A represents another process for automating some of the steps of the provisioning process. In this example, tracking tags with pre-printed visual codes such as QR codes or barcodes as described above may be arranged on a roll (as shown) or accordion style on a single longer, and in some cases periodically perforated, liner sheets in the card hopper 2210. The tracking tags may be pulled out of the hopper and adjacent to a chip interface 2220 via one or more rollers 2212, 2214 or other devices. The chip interface 2220 may establish a digital communication with the tracking tag, for example via spring or other contacts that physically contact with one or more electrical pads on the PCB of the tracking tag in order to identify the tracking tag identifiers. In some instances, the chip interface may also enable the end user to perform more dynamic operations such as detect battery level, automate verification of activation, or to write in encryption private keys. [symbol] The tracking tag identifier and any other information may be provided by the chip interface to a computing device (not shown or which may be incorporated into a printer 2240) which automatically associates the tracking tag identifier with a unique identifier for an object and stores this association in the storage system 250. Alternatively, the computing device may provide the association to the one or more server computing devices 108 or another computing device, such as the client computing devices 220, 230, 240.

Immediately thereafter, the one or more rollers 2212, 2214 or other devices may cause the tracking tags to enter into the printer 2240. The printer 2140 may include or may also be in communication with the computing device which provides the printer with the information identifying the unique identifier for an object. The printer may then print the information on the tracking tag, for example, at a location distinct from the pre-printed visual code in order to prevent overwriting.

The tracking tags may then be provided to an application device 2250, which applies the tracking tag to the object associated with the tracking tag identifier of that tracking tag. In this regard, the application device 2250 or the printer 2240 may also include a cutting device (not shown) in order to separate the tracking tags. The user may then activate the tracking tag, remove a liner sheet from the tracking tag to expose double-sided adhesive (as in the examples described above), and apply the tracking tag to the object associated with the tracking tag identifier of the tracking tag.

In some instances, the application device 2250 may also activate the tracking tag, for instance by using any of the activation mechanisms that may allow for automatic activation described above. This additional step may enable an end user to use a fully automated process and avoid the end user needing to activate the tracking tag, remove a portion of the longer liner sheet from the tracking tag to expose double-sided adhesive (as in the examples described above), and apply the tracking tag to the object associated with the tracking tag identifier of the tracking tag.

This fully automated provisioning process may even be configured to automatically detect failures. For instance, by using the chip interface to read the battery level from the tracking tag, the computing device can determine if the tracker has enough battery life for use. If no response comes from the tracking tag, it can be assumed that the tracking tag is inoperational (damaged or low battery) [symbol] As such, verification of the battery level (and therefore the remaining battery life) may be performed prior to activation by the end user. However, this does require a system that is able to automatically generate and provide the unique identifiers (e.g., tracking numbers) for the objects.

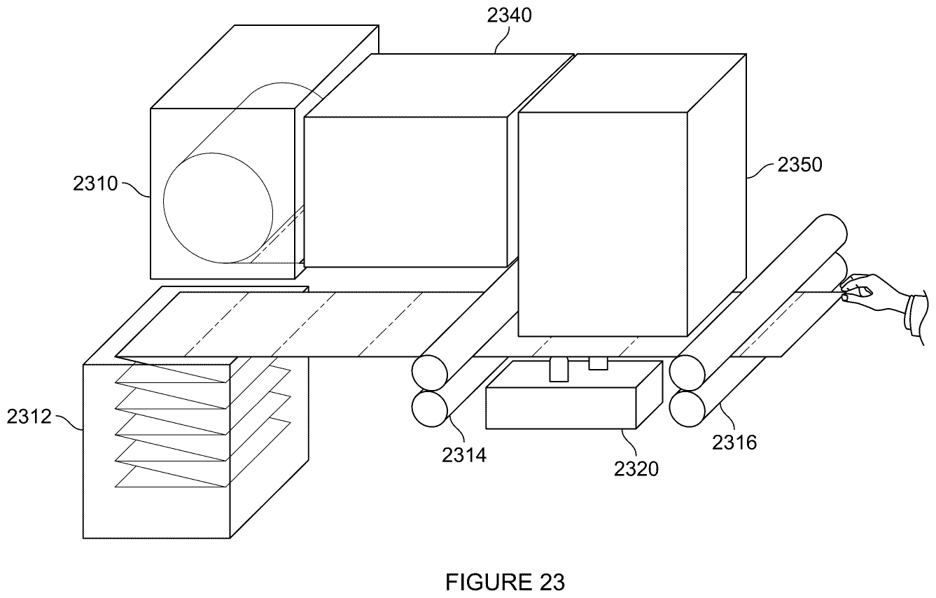

However, in some instances, the tracking tags may not be provided with the aforementioned pre-printed visual codes. FIG. 23 represents a process for automating the provisioning process when the tracking tags do not include the pre-printed visual codes. In this example, a roll of adhesive labels may be pulled from a storage container 2310 into a printer 2340. The printer 2340 may include or may also be in communication with the computing device which provides the printer with the information identifying a unique identifier for an object as well as a tracking tag identifier. The printer may then print the information on the adhesive labels.

In addition, the tracking tags may be arranged on a roll or accordion style (as shown) on a single longer, and in some cases periodically perforated, liner sheets in the card hopper 2312. The tracking tags may be pulled out of the hopper and adjacent to a chip interface 2320 via one or more rollers 2314, 2316 or other devices. The chip interface 2320 may function the same or similarly to the chip interface 2220 as described above.

The tracking tag identifier may be provided to a computing device (not shown or which may be incorporated into the printer 2340) which automatically associates the tracking tag identifier with a unique identifier for an object and stores this association in the storage system 250. Alternatively, the computing device may provide the association to the one or more server computing devices 108 or another computing device, such as the client computing devices 220, 230, 240. Thereafter, the printer may print the information on the adhesive labels as described above.

The tracking tags may then be provided to an application device 2350, which applies the printed top adhesive labels to the tracking tags. In this regard, the application device 2350 or the printer 2340 may also include a cutting device (not shown) in order to separate the adhesive labels. The user may then activate the tracking tag, remove a liner sheet from the tracking tag to expose double-sided adhesive (as in the examples described above), and apply the tracking tag to the object associated with the tracking tag identifier of the tracking tag.

In some instances, the application device 2350 may also activate the tracking tag, for instance by using any of the activation mechanisms that may allow for automatic activation described above. This additional step may enable an end user to use a fully automated process and avoid the end user needing to activate the tracking tag, remove a portion of the longer liner sheet from the tracking tag to expose double-sided adhesive (as in the examples described above), and apply the tracking tag to the object associated with the tracking tag identifier of the tracking tag.

As with the example of FIG. 22, the fully automated provisioning process of FIG. 23 may also be configured to automatically detect failures. For instance, by using the chip interface to read the battery level from the tracking tag, the computing device can determine if the tracker has enough battery life for use. If no response comes from the tracking tag, it can be assumed that the tracking tag is inoperational (damaged or low battery) [symbol] As such, verification of the battery level (and therefore the remaining battery life) may be performed prior to activation by the end user. However, this does require a system that is able to automatically generate and provide the unique identifiers (e.g., tracking numbers) for the objects.

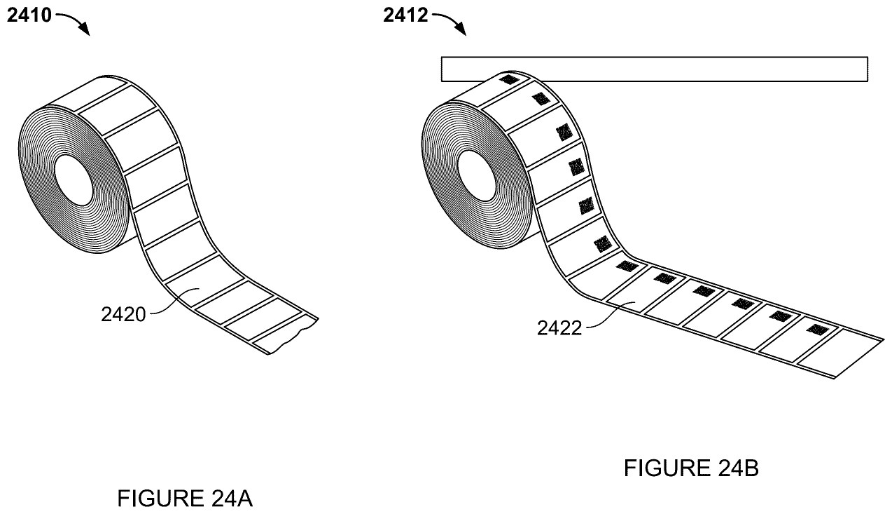

As noted above, the tracking tags may be manufactured and provided to the end users on a roll or accordion style with pre-printed visual codes. FIGS. 24A and 24B represent rolls 2410, 2412 of tracking tags 2420, 2422. Roll 2410 depicts tracking tags without pre-printed visual codes, and roll 2412 depicts tracking tags with pre-printed visual codes. As described above, the visual codes may embed the respective tracking tag identifiers on the tracking tags on which the visual codes are printed.

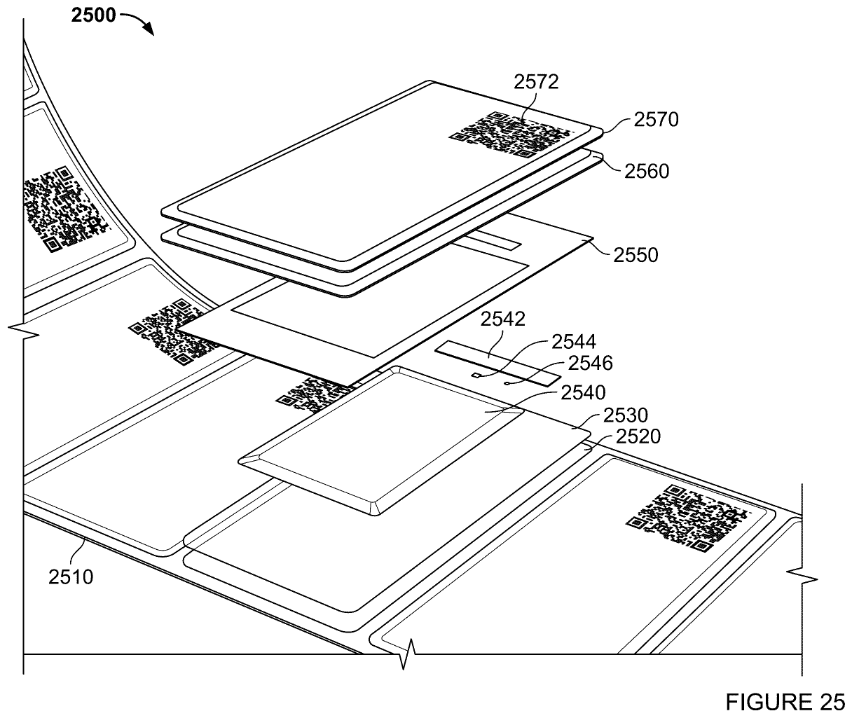

FIG. 25 is an example of an exploded view of tracking tag 2500. In this example, tracking tag 2500 may correspond to any of tracking tags 102, 104, 410, 414, 2422. In this example, the tracking tag 2500 is arranged on a liner sheet 2510 which may be the same or similar to any of the liner sheets described above. As in those examples, the liner sheet 2510 may protect an adhesive of a wet inlay 2520 which may include a substrate and the aforementioned adhesive. This adhesive may thus function similarly to the double-sided adhesives 540, 1340, 1570 discussed above. The wet inlay 2520 is arranged below a substrate 2530 and may also function similarly to the backing 730. 2530 may be a thin, flexible polycarbonate sheet or any other substrate suitable for electronics such as an RFID inlay (as shown in FIG. 25), PCB (as in the PCBs described above) or other such features.

The tracking tag 2500, as with the tracking tags described above, may also include beacon transmission circuitry. In this example, the beacon transmission circuitry includes a thin-film battery 2540 (which may be the same or similar to the one or more batteries 720) as well as an antenna 2542, integrated chip 2544 and capacitor 2546. These features may be arranged on the substrate 2530

The beacon transmission circuitry may be arranged at least partially within a frame 2550. In this example, the frame 2550 may be formed from foam and may therefore function as a gasket below a top cover 2560. In this example, top cover 2560 may be the same or similar to top cover 910. Above the top cover 2560 is a top adhesive label 2570 with a pre-printed visual code 2572 corresponding to the pre-printed visual codes described above.

Different manufacturing processes may be used to produce the tracking tags described herein on rolls such as rolls 2410, 2412. For example, tracking tag 2500 may be produced by starting with the wet inlay 2520 and the substrate 2530 with the antenna 2542 and circuit traces of the beacon transmission circuitry. Thereafter, the integrated chip 2544 and capacitor 2546 may be attached to the substrate 2530. This subassembly may then be placed on the liner sheet 2510, for example, along with other subassemblies.

The thin-film battery 2540 may be arranged on the subassembly and attached with conductive adhesive, staples and/or other features. At this point, the battery may be tested, for example, by utilizing a flying probe test jig connecting to pads on the inlay to verify battery and assembly of chip and capacitor, and any subassemblies or batteries which fail this testing may be discarded.

Thereafter, the frame 2550 may be placed over the thin-film battery 2540, the top cover 2560 and top adhesive label 2570 may be applied. In some instances, the top adhesive labels may be die cut after being placed on the top covers. At this point, the tracking tag has not yet been printed with a visual code, and thus corresponds to the tracking tag 2420 on roll 2410. The roll 2410 may be passed into a printer in order to print the visual codes on the tracking tags and thereby produce the tracking tag 2422 on roll 2412.

As an alternative, tracking tag 2500 may be produced by starting with the wet inlay 2520 and substrate 2530 with the antenna 2542 and circuit traces of the beacon transmission circuitry. Thereafter, the integrated chip 2544, capacitor 2546, and thin-film battery 2540 may be attached to the substrate form a subassembly. At this point, the battery may be tested as described above, and any subassemblies or batteries which fail this testing may be discarded.

After testing, the frame 2550 may be attached to the subassembly, and this subassembly may then be placed on the liner sheet 2510, for example, along with other subassemblies. Thereafter, the top cover 2560 and top adhesive label 2570 may be applied. In some instances, the top adhesive labels may be die cut after being placed on the top covers. At this point, additional testing may be performed, for example, by causing the tracking tag to transmit one or more beacon signals, and any subassemblies which fail this testing may be discarded.

Again, at this point, the tracking tag has not yet been printed with a visual code, and thus corresponds to the tracking tag 2420 on roll 2410. The roll 2410 may be passed into a printer in order to print the visual codes on the tracking tags and thereby produce the tracking tag 2422 on roll 2412.

The features described herein may provide for tracking tags with various benefits. Such tracking tags may have a thin profile while still being flexible, thus enabling the use of such tracking tags on any number of different types of objects. In other words, the same tracking tags may be suitable for attachment to objects with various form factors without the need to modify the shape and configuration of the tracking tags thereby simplifying the tracking of objects. In addition, the tracking tags described herein may be printed on and/or labels attached with information which may include identifying numbers, tracking numbers, etc. which can be converted to digital representations. Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same as or similarly elements.

1. A tracking tag comprising:
beacon transmission circuitry including one or more batteries;
a frame configured to hold the one or more batteries in place;
an adhesive arranged to secure the tracking tag to an object; and
an activation mechanism configured to activate the tracking tag and cause the beacon transmission circuitry to transmit beacon signals in order to enable tracking of the object.

2. The tracking tag of claim 1, further comprising an adhesive label.

3. The tracking tag of claim 2, wherein the adhesive label is a sheet of polyester or paper with an adhesive backing.

4. The tracking tag of claim 3, wherein the adhesive backing is a double-sided tape.

5. The tracking tag of claim 1, wherein the frame comprises a polycarbonate.

6. The tracking tag of claim 1, wherein the frame is a flexible frame which enables the tracking tag to be attached to objects having curved surfaces.

7. The tracking tag of claim 1, wherein the beacon transmission circuitry further includes a printed circuit board.

8. The tracking tag of claim 1, wherein the beacon transmission circuitry is arranged on a backing sheet.

9. The tracking tag of claim 8, wherein the backing sheet is a polycarbonate sheet.

10. The tracking tag of claim 8, wherein the backing sheet is an RFID inlay.

11. The tracking tag of claim 1, wherein the one or more batteries includes a coin cell, prismatic, pouch, thin-film or screen-printed battery.

12. The tracking tag of claim 1, wherein the frame includes a plurality of subframes which enable the tracking tag to be flexed between ones of the plurality of subframes.

13. The tracking tag of claim 12, wherein a first subframe of the plurality of subframes is configured to support a first one of the one or more batteries, and a second subframes of the plurality of subframe is configured to support a second one of the one or more batteries.

14. The tracking tag of claim 13, wherein a third subframe of the plurality of subframes is configured to support a printed circuit board of the beacon transmission circuitry.

15. The tracking tag of claim 1, further comprising a top cover and a bottom cover to provide impact protection.

16. The tracking tag of claim 15, wherein the top cover and the bottom cover comprise polycarbonate.

17. The tracking tag of claim 1, wherein the tracking tag has a thickness of less than 2.3 mm.

18. The tracking tag of claim 1, wherein the adhesive is a double-sided tape.

19. The tracking tag of claim 1, further comprising a removable sheet arranged on the adhesive in order to protect the adhesive prior to application of the tracking tag to an object.

20. The tracking tag of claim 1, wherein the activation mechanism includes a switch tab.

21. The tracking tag of claim 1, wherein the activation mechanism includes a liner sheet which includes a portion that wraps around and partially through the tracking tag in order to prevent a connection between the one or more batteries and another component of the beacon transmission circuitry and the liner sheet is configured to be removed from the tracking tag in order to activate the tracking tag.

22. The tracking tag of claim 1, wherein the activation mechanism further includes a conductive adhesive to form a bond between the one or more batteries and a copper tape once the tracking tag has been activated.

23. The tracking tag of claim 1, wherein the activation mechanism includes a pull tab.

24. The tracking tag of claim 1, wherein the activation mechanism includes a button configured to be pressed in order to activate the tracking tag.

25. The tracking tag of claim 1, wherein the activation mechanism includes an initially open circuit.

26. The tracking tag of claim 1, wherein the activation mechanism includes an initially closed circuit.

27. The tracking tag of claim 1, further comprising a Silicon Controlled Rectifier (SCR) circuit configured to maintain a connection in the beacon transmission circuitry once the tracking tag is activated.

28. The tracking tag of claim 1, wherein the activation mechanism includes a thermal switch.

29. The tracking tag of claim 1, wherein the activation mechanism includes a magnetic switch.

30. The tracking tag of claim 1, wherein the activation mechanism includes a removable bridge.

31. The tracking tag of claim 1, further comprising a light configured to flash when the tracking tag is activated.

32. The tracking tag of claim 1, wherein the frame is comprised of foam and functions as a gasket.

33. The tracking tag of claim 1, wherein the beacon transmission circuitry further includes an antenna, an integrated chip, and a capacitor.

34. The tracking tag of claim 1, wherein the tracking tag is arranged on a roll with a plurality of tracking tags.
